(19) United States
(12) Patent Application Publication
(10) Pub. No.: US 2024/0177494 A1
(43) Pub. Date: May 30, 2024

(54) AUTOMATIC IMPLEMENT RECOGNITION

(71) Applicant: Zimeno Inc., Livermore, CA (US)

(72) Inventor: Rama Venkata BHUPATIRAJU, Fremont, CA (US)

(73) Assignee: Zimeno Inc., Livermore, CA (US)

(21) Appl. No.: 18/525,470

(22) Filed: Nov. 30, 2023

Related U.S. Application Data
(60) Provisional application No. 63/429,126, filed on Nov. 30, 2022.
(60) Provisional application No. 63/429,137, filed on Nov. 30, 2022.

(51) Int. Cl. G06V 20/56; A01B 59/06; B60K 17/28; G06T 7/20; G06V 10/46; G06V 10/764

(52) U.S. Cl. CPC G06V 20/56; A01B 59/066; B60K 17/28; G06T 7/20; G06V 10/46; G06V 10/764

(57) ABSTRACT

Optical flow may be carried out on a series of images captured by the camera during movement of a candidate implement. Particular pixels may be aggregated based on relative pixel motion and classifying the particular pixels as belonging to the candidate implement. A candidate implement contour may be determined based on the particular pixels classified as belonging to the candidate implement. Based upon the comparison, control signals may be output to adjust operation of at least one of a tractor and the candidate implement attached to the tractor. In some implementations, the implement or its contour may be tracked and compared to a boundary for further vehicle control or operator alerts.

### CROSS-REFERENCE TO RELATED PATENT APPLICATIONS

The present non-provisional application claims priority from co-pending U.S. provisional patent Application Ser. No. 63/429,126 filed on Nov. 30, 2022, by Rama Venkata Bhupatiraju and entitled AUTOMATIC IMPLEMENT RECOGNITION SYSTEM, and co-pending U.S. provisional patent Application Ser. No. 63/429,137 filed on Nov. 30, 2022, by Rama Venkata Bhupatiraju and entitled VISION SAFETY SYSTEM, the full disclosures of which are hereby incorporated by reference.

### BACKGROUND

Many tractors are configured to push, pull and/or carry a variety of implements that are releasably attached to such tractors. Such implements, also referred to as attachments, may perform a variety of functions. Such implements may have different dimensions, may have or offer different operational states or different optional features, and may impose different operational requirements for the tractor to which the implement is attached.

### BRIEF DESCRIPTION OF THE DRAWINGS

FIG. 1 is a diagram schematically illustrating end portions of an example automatic implement recognition system.

FIG. 2 is a flow diagram of an example automatic implement recognition method.

FIG. 3A is a diagram of a series of images depicting movement of an example candidate implement.

FIG. 3B is a diagram schematically illustrating the aggregation of implement pixels in one of the series of images based upon optical flow analysis.

FIG. 3C is a diagram schematically illustrating the determination of a candidate implement contour in one of the series of images based upon the aggregation of implement pixels shown in FIG. 3B.

FIG. 3D is a diagram illustrating the candidate implement contour extracted from the image of FIG. 3C.

FIG. 4A is a diagram of a series of images depicting movement of an example candidate implement.

FIG. 4B is a diagram schematically illustrating the aggregation of implement pixels in one of the series of images based upon optical flow analysis.

FIG. 4C is a diagram schematically illustrating the determination of a candidate implement contour in one of the series of images based upon the aggregation of implement pixels shown in FIG. 4B.

FIG. 4D is a diagram illustrating the candidate implement contour extracted from the image of FIG. 4C.

FIG. 5 is a diagram illustrating an example lookup table associating different parameters with different stored implement contour identifiers.

FIG. 6 is a diagram schematically illustrating portions of an example automatic implement recognition system for use in determining a first state of an implement.

FIG. 7 is a diagram schematically illustrating portions of an example automatic implement recognition system for use in determining a second state of the implement of FIG. 6.

FIG. 8 is a diagram of an example image of the implement of FIG. 6 with aggregated pixels and a determined candidate implement contour.

FIG. 9 is a diagram of an example image of the implement of FIG. 7 with aggregated pixels and a determined candidate implement contour.

FIG. 10 is a flow diagram of an example automatic implement recognition method.

FIG. 11 is a perspective view of an example automatic implement recognition system comprising an example tractor.

FIG. 12 is a bottom view illustrate portions of the example tractor of FIG. 11.

FIG. 13 is a diagram depicting an example image captured by a camera of the example tractor of FIG. 11 and an example determined candidate implement contour displayed on the image.

FIG. 14 is a diagram depicting an example image captured by a camera of the example tractor of FIG. 11 and an example determined candidate implement contour displayed on the image.

FIG. 15 is a diagram depicting an example image captured by a camera of the example tractor of FIG. 11 and an example determined candidate implement contour displayed on the image.

FIG. 16 is a diagram depicting an example image captured by a camera of the example tractor of FIG. 11 and an example determined candidate implement contour displayed on the image.

FIG. 17 is a diagram schematically illustrating portions of an example implement tracking and control system.

FIG. 18 is a flow diagram of an example implement tracking and control method.

FIG. 19 is a diagram schematically illustrating an example series of images captured by a camera for use in implement tracking and control.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example automatic implement recognition systems, mediums and methods that facilitate automated recognition or identification of a particular type/version/state of an implement that is releasably attached to a tractor. Once the type/version/state of the implement has been automatically identified, the operation of the tractor and/or the operation of the implement may be automatically adjusted based upon the identification of the implement. In some implementations, once the attached implement has been automatically identified, an operator may be provided with recommendations for the operation of the tractor and/or operation of the implement based upon the identification of the implement.

The example automatic implement recognition systems, mediums and methods recognize or identify the particular type/version/state of implement by comparing a contour of a candidate implement to the stored or saved contours of previously identified implements. A sufficient match of the contour of the candidate implement to a particular one of the previously identified implements may result in the candidate implement being identified as being of the same type/version/state of the particular previously identified implement. If the contour of the candidate implement does not match the contour of any of the previous identified implements, the candidate implement is identified as a new type/version/state of implement, and its contour is saved to the store or library of previous identified implements. In such circumstances, one or more parameters may be associated with the new type/version/state of implement.

In some implementations, the store or library of previously identified implements may contain different contours for the same type/version of implement, wherein the different contours are as those of a particular type/version of implement in a particular state. For example, an implement may have a portion that is extendable and retractable or that is raised or lowered. Such implements are often extendable and retractable to facilitate transport or when traveling from or between fields, vineyards or orchards, such implement are often movable between raised and lowered states to accommodate or extend over plants of different heights. Examples of such implements include, but are not limited to, discs, plows, planters, sprayer booms and the like.

The store or library of previously identified implements may have a first stored contour for the implement when its portion is in an extended state and a second stored contour for the same implement when its portion is in a retracted state. In such implementations, the comparison of the candidate implement contour to the store or library of previously identified implements may not only indicate the type/version of implement currently attached to the tractor but also the current state of the implement attached to the tractor. In circumstances where the candidate implement contour does not match any previously stored and identified implements or implement states, the contour of the candidate implement may be added to the store or library as either a new type/version of implement and/or a new state for a previous identified type/version of implement.

The example automatic implement recognition systems, mediums and methods determine the contour of a candidate implement by carrying out optical flow on a series of images captured by a camera carried by the tractor during movement of the candidate implement. Such movement of the implement may be the result of the tractor pulling, pushing or carrying the implement in a forward or reverse direction while the implement remains stationary relative to the tractor. Such movement of the implement may be the result of the tractor pulling, pushing or carrying implement during turning of the tractor which may result in the implement pivoting relative to the tractor during the turn. Such movement of the implement may be the result of the tractor raising or lowering the implement relative to the tractor while the tractor is moving or while the tractor is stationary. For example, in some implementations, the tractor may comprise a tractor having a three-point hitch, wherein actuation of the three-point hitch raises or lowers the attached implement. In some implementations, the tractor may have a hydraulic coupling which supplies pressurized hydraulic fluid to a hydraulic jack (cylinder-piston assembly) carried by the implement, wherein the hydraulic jack raise or lowers the implement to move the implement.

During movement of the candidate implement, multiple digital images are captured by a camera carried by the tractor. The digital images are analyzed on a pixel by pixel or pixel group by pixel group basis to identify relative movement of pixels or pixel groups during the movement of the candidate implement (from the images of the candidate implement captured at different times and with the candidate implement at different positions). Those pixels or pixel groups that do not move relative to one another during movement of the implement are identified as being part of a single overall apparatus or structure and may be classified as belonging to or depicting part of the candidate implement. Such pixels or pixel groups are aggregated and classified as part of the candidate implement. The outer edges of such pixel or pixel group aggregations may be defined as the candidate implement contour. In some circumstances, gaps may exist between identified portions of the candidate implement contour. Such gaps may be digitally filled in using morphology.

Morphological operations in computer vision help in cleaning up the image and making certain features more pronounced. This helps in preparing the image for further processing, where the controller needs to recognize different parts of the image. Examples of morphology include erosion, dilation, opening and closing. Erosion involves the trimming of the edges of the shapes in the image to remove small specks. With dilation, image processing may make some parts of the image thicker or more prominent, like making certain features stand out. Opening is an imaging process that first trims away (erodes) the smaller details and then smooths out (dilates) what remains to clean up the image. With closing, the image processing may fill in small gaps or breaks in the shapes. Such closing may first expand the shapes to fill in the gaps and then trim the shapes back down to refine the shape.

As indicated above, each previously identified implement contours stored in the library may be associated with various parameters. The parameters may pertain to physical dimensions or configurations of the particular implement associated with the particular implement contour. The parameters may pertain to operational states that are available or that are recommended for the implement. The parameters may pertain to operational states that are available or that are recommended for the tractor when attached to the implement.

For example, the operational setting for the tractor may be selected from a group of operational settings for the tractor consisting of: a power takeoff speed or range of power takeoff speeds; a hydraulic coupling output pressure or range of hydraulic coupling output pressures; a three-point hitch height or range of three-point hitch heights; and PTO RPM speed limits. The operational setting for the tractor may be selected from a group of operational settings for the tractor consisting of: steering of the tractor and speed of the tractor (such as a speed based on GPS signals/measurements). The controller may output control signals adjusting various components of the tractor, such as PTO settings, hydraulic settings, speed controls, tractor path planning (based upon the width of the implement) that are customized for the recognized implement. Such automatic recognition may facilitate faster implement hook up and/or disconnection.

In some implementations, the comparison of the candidate implement contour to a previously stored implement contour may result in an operator of the tractor being provided with a notification, warning or recommendation. The notification may inform the operator of the type/version/state of the implement currently attached to the tractor. The notification may be in the form of a warning indicating damage or a malfunction to the implement based upon the comparison of the candidate implement contour and the stored implement contour. The notification may warn the operator that the currently attached implement is not compatible with the tractor to which it is attached.

The notification may be in the form of a recommendation recommending that the operator manually provide input or commands to adjust the operation of the tractor and/are the implement to recommended operational settings or states. In some implementations, the tractor may be in the form of a tractor comprising an electric motor and a battery to power the electric motor, wherein the instructions are further configured to direct the processing resource to output a notification indicating an estimated remaining battery duration based on the comparison.

Disclosed are examples of a vision safety systems or implement tracking and control systems which automatically identify circumstances where a footprint of an implement is about to travel across a determined boundary (sometimes referred to as safety guard rails) which may result in damage to the implement, damage to plants of a field, vineyard or orchard, or which may result in damage or injury to other structures or persons. In such example implementations, a controller may determine the footprint of the implement from the identified implement contour as described above. The implement's footprint may be determined using optical flow approach. When the vehicle or tractor is in motion, both the implement and the tractor frame have similar motion with respect to background as implement is attached to the tractor. Those pixels of images of the implement and tractor frame are aggregated to identify the footprint of the tractor and the footprint of the implement.

In such examples, the controller may determine a path boundary for the implement. The path boundary may correspond to plant rows of a vineyard, orchard or crop field, wherein crossing of such boundaries by the implement may result in damage to the plant rows. The path boundary may be determined based upon images received from various 2D and sets are 3D cameras or other sensors (lidar sensors) carried by the tractor and/or implement. For example, the boundary or boundary layer may be determined using a front stereo camera which may provide both two-dimensional (RGB) and three-dimensional point cloud information. Computer vision and deep learning techniques (machine learning) may be utilized to identify and determine the stems (roots) of plant rows, wherein such stems on the same plant liner joined to identify a crop or plant line which serves as a boundary layer. This boundary layer serves as a barrier layer across which the implement should not pass.

In such implementations, the identified contour footprint of the implement and/or tractor are tracked across several image frames to determine translation and rotation of the implement at each frame by comparing it to a previous template or frame. In some implementations, the image frames that are used for tracking motion of the tractor/implement footprint may be provided with two cameras: a stereo vision camera at a front of the tractor along with a monocular camera which is at a rear of the tractor facing directly towards the ground. The determined rotation and translation motion is used by the controller to predict the future path or where the implement is expected to be in the future. In response to such motion resulting in implement traveling across the safety/boundary layer or line of plant rows, the controller may automatically output control signals causing the tractor to slow down, adjusting the steering of the tractor and/or alerting an operator of the forthcoming boundary infringement.

For purposes of this application, the term “processor” or “processing unit” shall mean a presently developed or future developed computing hardware that executes sequences of instructions contained in a non-transitory memory. Execution of the sequences of instructions causes the processing unit to perform steps such as generating control signals. The instructions may be loaded in a random-access memory (RAM) for execution by the processing unit from a read only memory (ROM), a mass storage device, or some other persistent storage. In other embodiments, hard wired circuitry may be used in place of or in combination with software instructions to implement the functions described. For example, a controller may be embodied as part of one or more application-specific integrated circuits (ASICs). Unless otherwise specifically noted, the controller is not limited to any specific combination of hardware circuitry and software, nor to any particular source for the instructions executed by the processing unit.

For purposes of this disclosure, unless otherwise explicitly set forth, the recitation of a “processor”, “processing unit” and “processing resource” in the specification, independent claims or dependent claims shall mean at least one processor or at least one processing unit. The at least one processor or processing unit may comprise multiple individual processors or processing units at a single location or distributed across multiple locations.

For purposes of this disclosure, the term “coupled” shall mean the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate member being attached to one another. Such joining may be permanent in nature or alternatively may be removable or releasable in nature. The term “operably coupled” shall mean that two members are directly or indirectly joined such that motion may be transmitted from one member to the other member directly or via intermediate members. The term “fluidly coupled” shall mean that two or more fluid transmitting volumes are connected directly to one another or are connected to one another by intermediate volumes or spaces such that fluid may flow from one volume into the other volume.

For purposes of this disclosure, the phrase “configured to” denotes an actual state of configuration that fundamentally ties the stated function/use to the physical characteristics of the feature proceeding the phrase “configured to”.

For purposes of this disclosure, the term “releasably” or “removably” with respect to an attachment or coupling of two structures means that the two structures may be repeatedly connected and disconnected to and from one another without material damage to either of the two structures or their functioning.

For purposes of this disclosure, unless explicitly recited to the contrary, the determination of something “based on” or “based upon” certain information or factors means that the determination is made as a result of or using at least such information or factors; it does not necessarily mean that the determination is made solely using such information or factors. For purposes of this disclosure, unless explicitly recited to the contrary, an action or response “based on” or “based upon” certain information or factors means that the action is in response to or as a result of such information or factors; it does not necessarily mean that the action results solely in response to such information or factors.

For purposes of this, unless explicitly recited to the contrary, recitations reciting that signals “indicate” a value or state means that such signals either directly indicate a value, measurement or state, or indirectly indicate a value, measurement or state. Signals that indirectly indicate a value, measure or state may serve as an input to an algorithm or calculation applied by a processing unit to output the value, measurement or state. In some circumstances, signals may indirectly indicate a value, measurement or state, wherein such signals, when serving as input along with other signals to an algorithm or calculation applied by the processing unit may result in the output or determination by the processing unit of the value, measurement or state.

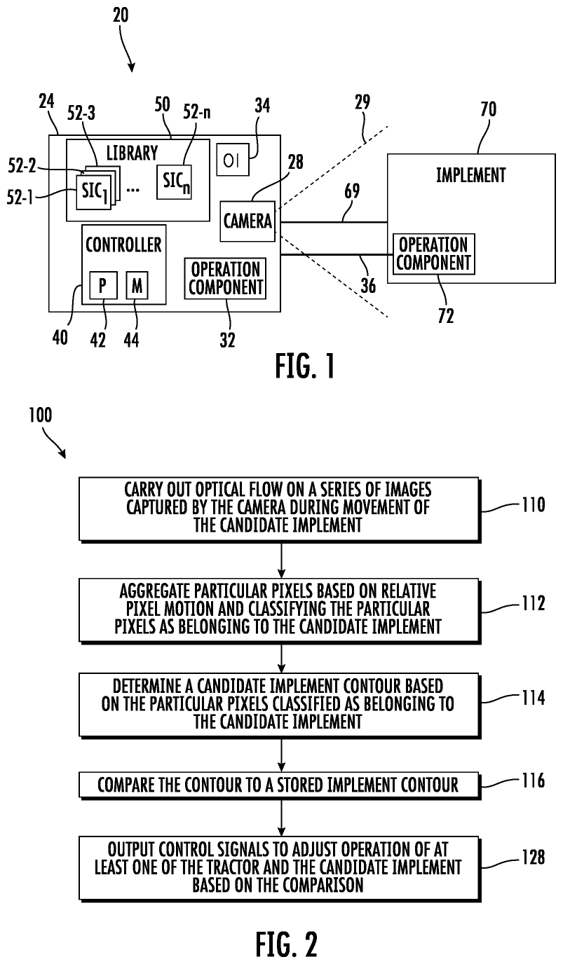

FIG. 1 schematically illustrates portions of an example automatic implement recognition system 20 facilitates automatic recognition of an implement attached to a tractor. System 20 comprises tractor 24, camera 28, and controller 40. Tractor 24 comprises configured to push, pull or carry an implement (sometimes also referred to as an attachment) using a connection 69 (schematically illustrated). Examples of connection 69, include, but are not limited to, a drawbar hitch and a three-point hitch. In the example illustrated, the tractor 24 (schematically illustrated) is illustrated as being attached to an implement 70 (also schematically illustrated). Both tractor 24 and implement 70 comprise at least one operation component. Tractor 24 comprises operation component 32 while implement 70 comprises operation component 72.

Operation component 32 comprises a component of tractor 20 that carries out an operation which may alter the state of tractor 24. Operation component 32 may comprise a component or multiple components of a steering system, such as a steer by wire system, which in response to receiving a steering command, from an operator using a steering wheel or other input device or from an automated routine, outputs control signals adjusting the yaw or angle of the tractor 24 by turning the wheels or tracks of the. Operation component 32 may comprise or multiple components of a propulsion system of tractor 24. The propulsion system component may comprise components of an electric motor, a hydraulic motor, an internal combustion engine and/or a transmission that transmits torque from the electric motor, hydraulic motor and such or internal combustion engine to the wheels or tracks of the tractor 24 to propel or drive the tractor 24.

Operation component 32 may comprise one or more components of tractor 24 that interact with implement 70. In the example illustrated, tractor 24 comprises a power transmission connection 36 by which power submitted to implement 70. The power connection may be in the form of an electrical power outlet, line or cable by which a logical power may be transmitted to implement 70 or a hydraulic coupling by which pressurized hydraulic fluid may be supplied to implement 70 to hydraulically power hydraulic components of implement 70, such as a hydraulic jack (cylinder-piston assembly) and/or a hydraulic motor. In some implementations, the power connection 36 may comprise a power take off (PTO) such as a splined shaft. In some implementations, one of the possible power components 32 may be in the form of a tractor hydraulic jack or other mechanical actuator that controllably raises and lowers a three-point hitch of tractor 24, wherein the three-point hitch serves as the implement connection 69. In yet other implementations, implement connection 69 may comprise a drawbar hitch.

Operation component 72 comprises one or more components of implement 70 that alter the state of implement 70. In some implementations, operation propulsion 72 may cooperate with operation component 32 two result in the state of implement 70 being changed. Operation propulsion 72 may comprise a component locally residing on implement 70 such as a hydraulic motor, hydraulic pump, a hydraulic jack, and electric solenoid and/or mechanical components such as bars, levers, arms, transmissions or the like that transmit power or motion to raise, lower, or otherwise move selected portions of implement 70. In some implementations, implement 70 may omit operation component 72, such as where implement 70 is simply pulled, pushed or carried by tractor 24. Examples of such an implement 70 may be in the form of a trailer.

In the example illustrated, tractor 24 additionally comprises operator interface 34. Operator interface 34 comprises one or more devices configured to communicate with an operator residing on tractor 24, an operator observing or controlling tractor 24 from a remote location, or persons not residing on tractor 24, proximate to tractor 24. Operator interface 34 may receive input from an operator in the form of manual manipulations, audible input or gesture input. Operator interface 34 may comprise a steering wheel, a joystick, a touchscreen, a keyboard, a touchpad, a mouse, a button, switch or lever, a microphone with speech recognition, or a camera with optical recognition software. Operator interface 34 may additionally or alternatively comprise a device that outputs information, such as a notification, alert or warning, to an operator or those about, not on, tractor 24. Operator interface 34 may comprise a speaker for auditory output, a monitor or screen for outputting images and/or text, and/or one or more lights, wherein the on/off state, color, brightness and/or flashing frequency of the one or more lights may communicate information to an operator and/or those near tractor 24.

Implement 70 may be one of multiple possible different implements that may be releasably connected or attached to tractor 24. Each of such different implements may have different dimensions, may have or offer different operational states or different optional features, and may impose different operational requirements for tractor 24 when attached to tractor 24. Examples of implement 70 include, but are not limited to, trailers, mowers, sprayers, disc harrows, rotary tillers, cultivators, under vine weeders, and manure/compost spreaders, and the like.

In some implementations, implement 70 may have portions which are movable relative to a remainder of the implement 70. For example, portions of an implement 70 may be raised or lowered or portions may be extended or retracted. Such portions may be raised to accommodate different plant heights. Such portions may be retracted to accommodate transport, storage, or road travel, wherein such portions are extended for carrying out operations in a field, orchard or vineyard. Examples of such implements include, but are not limited to, sprayers, spreaders, cultivators, plows, cultivators, planters (including planting drills) and the like.

As will be now described, camera 28 and controller 40 facilitate the identification of the particular type, version and/or state of implement 70, wherein the identification of what particular type of implement is attached to tractor 24, what particular version of a particular type of implement is attached to tractor 24 and/or the particular state of the attached implement may be used as a basis for adjusting the operation of operation component 32 and/or operation component 72. The identification of what particular type of implement is attached to tractor 24, what particular version of a particular type of implement is attached to tractor 24 or the particular state of the attached implement may additionally or alternatively be used as a basis (1) for prompting or receiving input from an operator and/or (2) for communicating to the operator or those about tractor 24 using operator interface 34.

Camera 28 comprises one or more cameras configured to capture a series of images. Camera 28 may be in the form of a two-dimensional camera or a three-dimensional camera. Camera 24 may capture individual images or video which may be parsed into a series of images. Camera 28 is mounted or provided as part of tractor 24 so as to have a field-of-view 29 (shown by broken lines) configured to encompass the candidate implement that is attached to tractor 24. Images from camera 20 are transmitted to or supplied to controller 40.

Controller 40 comprises processor 42 (also referred to as a processing unit) and memory. Memory 44 comprises a non-transitory computer-readable medium containing instructions configured to direct processing unit 42 to perform analysis, prompt for the input of commands or data, retrieve and store data, and output control signals. In the example illustrated, controller 40 resides on tractor 24. In some implementations, controller 40 may be remote, such as provided by a control station or management station which communicates with a local controller on tractor 24 in a wireless fashion, or such as provided by a cloud-based system or server, wherein controller 40 communicates with a computer or controller locally residing on tractor 24 and may communicate with other vehicles in a similar fashion, such as vehicles in a fleet of vehicles. In some implementations, portion of controller 40 may be remote or cloud-based while other portions of controller 40 may locally reside on tractor 24.

In the example illustrated, memory 44 contains instructions configured to direct processor 42 to perform the example automatic implement recognition method 100 represented by the example flow diagram of FIG. 2. As indicated by block 110 in FIG. 2, instructions in memory 44 direct processor 42 to carry out optical flow on a series of images captured by the camera 28 during movement of the candidate implement 70. The characterization of implement 70 as a “candidate” implement refers to the current state of implement 70 as not being recognized or identified; the type/version/state of implement 70 as not yet been identified.

The optical flow is a process by which the distribution of apparent velocities movement of brightness patterns in an image are analyzed. An analysis of such sequences of ordered images facilitates the estimation of motion. In the example illustrated, such flow is carried out on a pixel by pixel or pixel group by pixel group basis to evaluate identify any relative movement as between pixels or pixel groups. Those pixels or pixel groups which do not move relative to one another in the series of images may be identified by controller 40 as depicting portions of a single mechanical structure such as portions of the candidate implement 70 (portions of which are not changing between states (raised, lowered, retracted, extended) during the movement of implement 70 during which a series of images are captured). In contrast, those pixels or pixel groups which move relative to one another in the series of images may be identified by controller 40 as depicting different mechanical structures or different items. For example, particular pixels may be identified as possibly belonging to the candidate implement 70 (implement pixels) while other pixels that move relative to the implement pixels may be identified by controller as non-implement pixels, such as pixels depicting rear portions of tractor 24 and/or the general environment underlying and surrounding implement 70.

In some implementations, the identification of a group or aggregation of pixels as depicting a candidate implement may additionally be based upon the size of the aggregation of pixels and the relative positioning of such aggregated pixels in the image. For example, and aggregation of pixels centered in the image may be determined to be that of a candidate implement based on the presumption that the candidate implement is attached to the tractor and is centered along the longitudinal axis of the tractor with the camera also adding a field-of-view also centered along the longitudinal axis of the tractor.

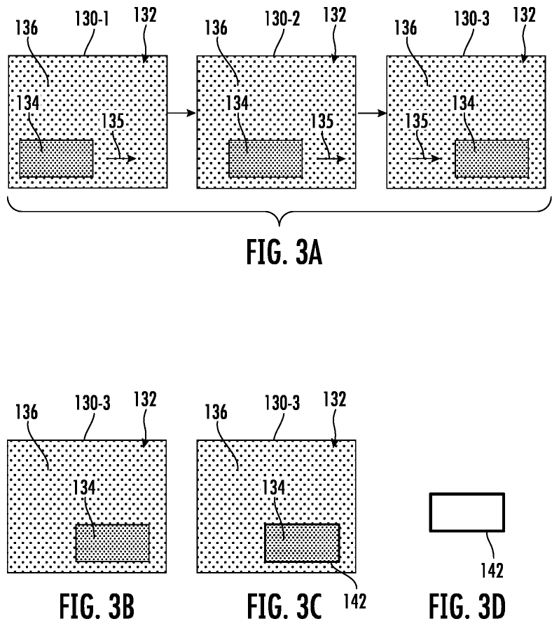

FIG. 3 illustrates an example series of digital images 130-1, 130-2 and 130-3 captured by camera 28 and comprising pixels 132 which comprise implement pixels 134 and non-implement pixels 136. Although the implement pixels 130 for those of a schematically represented pixel having a rectangular shape, at such implement pixels 134 may have a variety of different sizes, shapes and configurations depending upon the actual candidate implement 70 captured by such images. In the example illustrated, the images 130-1, 130-2 and 130-3 (collectively referred to as images 130) illustrate movement of the candidate implement 70, over time, to the right as indicated by arrow 135. Such movement may be the result of tractor 24 turn or being steered such that implement 70 pivots about a hitch pin or such that implement 70 is carried to the right (such as when implement 70 is being carried by a three-point hitch).

As indicated by block 114 of FIG. 2 and schematically represented by FIG. 3B, based upon the above optical flow analysis of images 130, controller 40 aggregates particular pixels (the implement pixels 134) based on relative pixel motion and classifying the implement pixels 134) as belonging to the candidate implement 70. As shown by the example series of images, the implement pixels 134 moving substantial unison with one another (no relative movement amongst the implement pixels 134) but move relative to the non-implement pixels 136. Based upon this distinction discerned by optical analysis by processor 42 following instructions contained in memory 44, controller 40 may deem or classify implement pixels 134 as belonging to the candidate implement 70 and may deem or classify the non-implement pixels 136 as belonging to the background or environment of candidate implement 70. The aggregation of the implement pixels 134 is shown in FIG. 3B.

As indicated by block 114 in FIG. 2 and schematically represented in FIG. 3C, controller 40 determines a candidate implement contour 142 (shown by a thicker line) based upon the particular pixels 134 that were aggregated and classified as belonging to candidate implement 70. This contour 142 serves as an outline of the outer edges or perimeter of the candidate implement 70, from the vantage point of camera 28. In some circumstances, portions of contour 142 may include gaps due to brightness similarities of adjacent pixels. In such implementations, controller 40 may fill in such gaps of contour 142 using morphology (described above).

FIG. 3D illustrates the particular determined contour 142 of the candidate implement 70, extracted from the images 130. As indicated by block 116 of FIG. 2, controller 40 compares the determined candidate implement contour 142 with one or more stored implement contours (SICs).

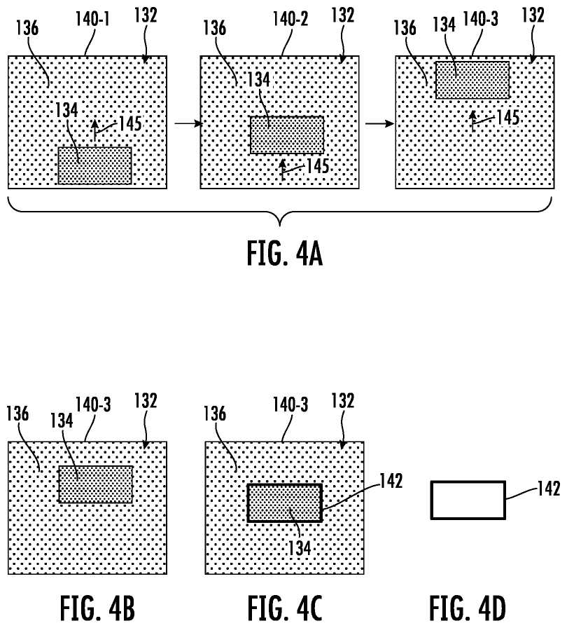

Although FIGS. 3A-3D illustrate the use of optical flow to identify aggregate those pixels estimated to be pixels of implement 70 and to identify the outline or contour 142 of implement 70 during horizontal movement of implement 70, the same process may be carried out using optical flow during any combinations of horizontal and/or vertical movement of implement 70 FIGS. 4A-4D illustrate the same processes as set forth in FIG. 3A-3D, respectively, for vertical movement of implement 70. FIG. 4A illustrates a series of images 140-1, 140-2 and 140-3 (collectively referred to as images 140) captured by camera 28 during upward or vertical movement as indicated by arrows 145. Such vertical movement by implement 70 may be in response implement 70 encountering a bump or drop in the underlying terrain as implement 70 (with its own ground engaging members or wheels) is being pushed/pulled by tractor 24 or may be in response implement 70 being carried by tractor 24 and being raised or lowered by tractor 24, such as with the raising or lowering of a three-point hitch.

FIG. 4B illustrates the aggregation of pixels 134, similar to aggregation of pixels 134 in FIG. 3B. FIG. 4C illustrates the determination and identification of the candidate implement contour 142, similar to the identification of the contour 142 in FIG. 3C. FIG. 4D illustrates the extraction of the identified CIC 142 for comparison with one or more SICs.

As shown by FIG. 1, system 20 may comprise a store or library 50 containing the contours of different implements previously identified from images captured by camera 28, another camera on a different tractor 24, or vehicle but having the same vantage point or rearward field-of-view as that of camera 28. For example, such stored implement contours may be determined based upon images captured by other tractors similar or identical to tractor 24 having a camera similar to camera 28 mounted the same location on such other tractors.

In the example illustrated, library 50 comprises stored implement contours 52-1, 52-2, 52-3 . . . 52-n (collectively referred to as contours 52). Each of the stored implement contours 52 may be a stored outer profile, shape or outline of a particular type of implement. In some implementations, different contours 52 may be that of the same type of implement, but different versions of the implement. In some implementations, different contours 52 may be that of the same implement type and version, but with actuatable portions in different positions or states. Each of the stored implement contours may be associated with a particular implement type, version or state label identifier or label. As will be described hereafter, in some implementations, each of the SICs 52 may also be directly (or indirectly via an identifier) associated with one or more parameters that identify a particular response when a particular CIC matches a particular SIC 52.

Library 50 may reside locally on tractor 24 or may be remote from tractor 24, controller 40 accesses library 50 in a wireless fashion. For example, library 50 may reside on a central farm, vineyard or orchard communication station and communicates with those tractors 24 of the particular farm, vineyard or orchard. Library 50 may reside on a cloud-based server system, wherein controller 40 may access library 50. In those implementations where library 50 locally resides on tractor 24, controller 40 may periodically update library 50 to include new or additional SICs determined by controller 40 from a series of images captured by cameras on other tractors 24. In such implementations, controller 40 may likewise upload any new SICs to update any remote library of SICs. Such uploading may occur while tractor 24 is in a particular field, vineyard or orchard or while tractor 24 is docked in a storage shed or at a central farm, vineyard or orchard communication station.

As will be described hereafter, in some implementations, the candidate implement contour (CIC) identified or determined in block 114 may not match any of the current SICs contained in library 50. In such circumstances, controller 40 may store the CIC as a new SIC in library 50. In such a fashion, library 50 may be automatically updated to include newer types of implements or versions of implements.

As indicated by block 128 of FIG. 2, based upon the comparison performed in block 116, controller 40 may output control signals to adjust operation of at least one of tractor 24 and the candidate implement 70. In some implementations, the control signals may be output in response to the particular CIC not matching or not sufficiently matching any prior SICs in library 50. In some implementations, the control signals may be output in response to the CIC of implement 70 matching or sufficiently matching a particular SIC in library 50.

In some implementations, a CIC may be deemed to sufficiently match a prior SIC in response to the percentage of the number of pixels in the CIC having a location that matches the location of pixels in the SIC exceeding a predefined matching threshold. In some implementations, a CIC may be deemed to sufficiently match a prior SIC in response to no pixels in the CIC being spaced from or distanced from corresponding pixels in the SIC by a distance exceeding a predefined matching distance threshold. In some implementations, controller 40 determines the spacing of each pixel in the CIC from the closest or corresponding pixel in the SIC and determines the percentage of those pixels that are spaced from the closest corresponding respective pixels of the SIC by distance less than a distance threshold. A CIC may be deemed to sufficiently match a prior SIC in response to the percentage of such pixels that satisfy the distance threshold being greater than a predefined percentage. In some implementations, controller 40 may compare the actual shapes of the CIC and SIC, wherein the CIC is deemed to sufficiently match the SIC in response to the two shapes being different by a degree less than a predefined shape matching threshold. In yet other implementations, other techniques may be employed to compare the CIC with each of the SICs to identify sufficient match.

Each of the SICs 52 may be linked to or have an associated parameter. In some implementations, each SIC may be part of a lookup table having one or more associated parameters. FIG. 5 illustrates an example lookup table 200 which associates each of four example SIC labels/identifiers 202-1, 202-2, 202-3 and 202-4 (collectively referred to as identifiers 202 with respective values and/or requirements for parameters 204-1, 204-2, 204-3, 204-4, 204-5 and 204-6 (collectively referred to as parameters 204). The identifiers 202 are names or labels applied to or associated with the particular stored implement contours 52 described above. The parameters 204 refer to different parameter types or categories, wherein each individual type or category may have different associated actual values, settings and/or instructions (schematically represented as variables A-R). Although table 200 is illustrated as including four stored SIC's and six associated parameters, it should be appreciated that to into hundred may comprise a greater or fewer number of SICs and a greater or fewer number of parameters.

In response to a CIC sufficiently matching a particular SIC 52, controller 40 may consult a lookup table 200 to determine the values for those parameters 204 associated with the particular identifier 202 that corresponds to the particular SIC 52. For example, in response to a CIC matching SIC 52-2 which corresponds to identifier 202-2, controller 40 may consult lookup table 200 which indicates that for the particular identified candidate implement, the parameters 204-1, 204-3, 204-4, 204-5 and 204-6 should have the values, settings and/or control instructions B, H, J, M and P, respectively. In the example illustrated, when the candidate implement is identified as SIC 52-2 having the identifier 202-2, as indicated by “N/A” (not applicable), there are no parameter values settings or control instructions for parameter 204-2.

Such different parameter values, settings and/or control instructions, may have a variety of forms. Such parameters 204 and their associated values, settings and/or control instructions may prescribe or dictate certain actions or operational states for tractor 24 and/or implement 70. Some parameters 204 may dictate the automatic action or automatic adjustment to the operational state without operator approval, authorization or input. Some parameters 204 may dictate that final authorization or approval be received by the operator (through operator interface 34) before implementing a change based upon the particular parameter 204. Some parameters 204 may dictate immediate automatic or automated action in response to an identified match between the CIC and the SIC. Some parameters 204 may dictate a predetermined delay of time between the time that the match is identified and the automatic output of control signals to adjust an operational state.

In some circumstances, the parameter 204 associated with the matched SIC identifier 202 may call for particular operational states or adjustments for tractor 24. In such an implementation, controller 24 may adjust an operational state of operation component 32. The parameter 204 associated with the matched SIC or its identifier may call for one or more operational settings of the tractor 24 selected from a group of operational settings consisting of: a power takeoff speed or range of power takeoff speeds; a hydraulic coupling output pressure or range of hydraulic coupling output pressures; a three-point hitch height or range of three-point hitch heights; and guardrail safety distance. For example, the controller 24 may modify the safety distance based on the implement length. When humans come close to the implement controller 24 may output signals to stop. The parameter 204 associated with the matched SIC 52 or its identifier 202 may additionally or alternatively call for one or more operational settings of the tractor 24 selected from a group of operational settings consisting of: steering of the tractor 24, speed of the tractor 24, and GPS speed.

For example, in some implementations, parameter 204-2 may pertain to a recommended power takeoff speed or range of power takeoff speeds for different implements, wherein the values E, F, and G are numerical values for such recommended speeds or speed ranges. In the example, the implement identifier 202-2 may not utilize power provided by power takeoff, resulting in the N/A value. In some implementations, parameter 204-1 may pertain to a recommended speed for tractor 24 pulling the particular implement or recommended range of speeds are maximum or minimum speeds for the tractor 24 pulling the particular implement while it is in operation. In such an example, the values A-D are numerical values for such recommended tractor speeds for the different implements 202. Such parameters may be utilized by controller 540 to budget or estimate time for an operation or to determine a routine for automated operation of the tractor and its implement.

In some implementations, one or more of the parameters 204 may pertain to different values associated with the implement 70. For example, in some implementations, the parameter 204-6 may pertain to the width of implement 70. In other implementations, the parameter 204-6 may pertain to the height of implement 70. In some implementations, the parameter 204-6 may pertain to the weight or towing demands of implement 70. Such values O, P, Q, R may be used by controller 40 to determine an operational setting of tractor 24 or the interaction of tractor 24 with implement 70 in response to a particular type/version/state of the particular implement attached to tractor 24. For example, in some implementations, parameter 204-6 may indicate the different widths of those implements with identifier 202. This value may be used by controller 40 to output steering commands to tractor 24 to appropriately locate tractor 24 and the particular attached implement 70 when implement 70 is being parked or stored, when implement 70 is interacting with the ground or plants, or when implement 70 is being pushed, pulled or carried between plant rows.

In some circumstances, the parameter 204 associated with the matched SIC or its identifier may call for controller 40 to monitor particular components of tractor 24 or of implement 70 or states/conditions of tractor 24 implement 70. For example, with some implementations, it may be beneficial to monitor or track particular components or conditions whereas with other implements, it may be beneficial to monitor or track other particular components or conditions. The identification of the type, version and/or state of the implement 70 may assist in determining what provided sensors on tractor 24 should be activated or polled or what sensors on implement 70 should be activated or polled.

For example, the parameter 204-4 may indicate what components or conditions of tractor 24 should be monitored with one or more sensors provided on tractor 24. Parameter 204-4 may indicate what components and such or conditions of implement 70 should be monitored with one or more sensors provided on implement 70 and in communication with controller 40. Examples of such sensors include cameras, pressure sensors, force sensors and the like.

In the example illustrated, table 200 indicates that controller 40 should monitor the tractor and/or implement component or a particular condition I of the tractor when implement 202-1 is attached to tractor 24 and that controller 40 should monitor the particular component and/or condition J when implement 202-2 is attached to tractor 24. The instructions I and J may further indicate or prescribe the frequency at which such components or conditions should be monitored, may prescribe what particular sensors should be used to carry out such monitoring, and may prescribe particular threshold values and what notifications or actions should be taken in response to or based upon the threshold being satisfied. Controller 40 carries out such prescribed actions as indicated by the instructions I and J in response to tractor 24 being attached to implements having contours matching those SICs having identifiers 202-1 and 202-2, respectively.

In some implementations, controller 40 may determine whether the implement is three-point attached or draw bar attached implement. A draw bar implement can move around the draw bar, sideways. A three-point hitch attachment has no or limited ability to move sideways. In response to the implement being a draw bar attached implement, controller may automatically monitor sideways movement of the implement with the rearward facing camera. In response to such monitored sideways motion exceeding a predetermined threshold, controller 40 may output an alert notification or may take automatic remedial action by outputting control signal to slow the vehicle or limit turning by the vehicle.

In some circumstances parameters associated with a matched SIC may prescribe particular thresholds for potential actions and/or notifications. For example, a first parameter associated first type of implement or a first state of an implement may prescribe that an action or warning be initiated or output in response to a first threshold for a measured, calculated or sensed value made or received by controller 40, whereas a second parameter associated a second different type of implement or a second state of the same implement may prescribe that the same action or warning be initiated or output in response to a second threshold, different than the first threshold, for the same measured, calculated or sensed value made or received by controller 40. In some implementations, two different parameters associated corresponding different SICs may prescribe different actions or warnings in response to the same measured, determined or sensed value made or received by controller 40.

In some implementations, the comparison of the candidate implement contour to a previously stored implement contour may result in an operator of the tractor being provided with a notification, warning or recommendation. The notification may inform the operator of the type/version/state of the implement currently attached to the tractor. The notification may be in the form of a warning indicating damage or a malfunction to the implement based upon the comparison of the candidate implement contour and the stored implement contour. The notification may be in the form of a recommendation recommending that the operator manually provide input or commands to adjust the operation of the tractor and/are the implement to recommended operational settings or states. In some implementations, the tractor may be in the form of a tractor comprising an electric motor and a battery to power the electric motor, wherein the instructions are further configured to direct the processor to output a notification indicating an estimated battery duration based on the comparison.

As indicated above, in some implementations, the comparison of a particular candidate implement contour 142 to stored implement contours 52 may be used to determine the state of a particular implement. In such implementations may include stored implement contours 52 of the same implement, but in different states. For example, library 50 may contain a first SIC of an implement having booms or wings in a retracted state (such as a state when the implement is being transported or stored) and a second SIC of the same implement having the booms or wings in extended states. Library 50 may contain a first SIC of an implement in a raised state (such as with a sprayer which may be raised and lowered based upon plant height), a second SIC of the same implement in a first lowered states, and a third SIC of the same implement in a second lowered state different than the first lowered state.

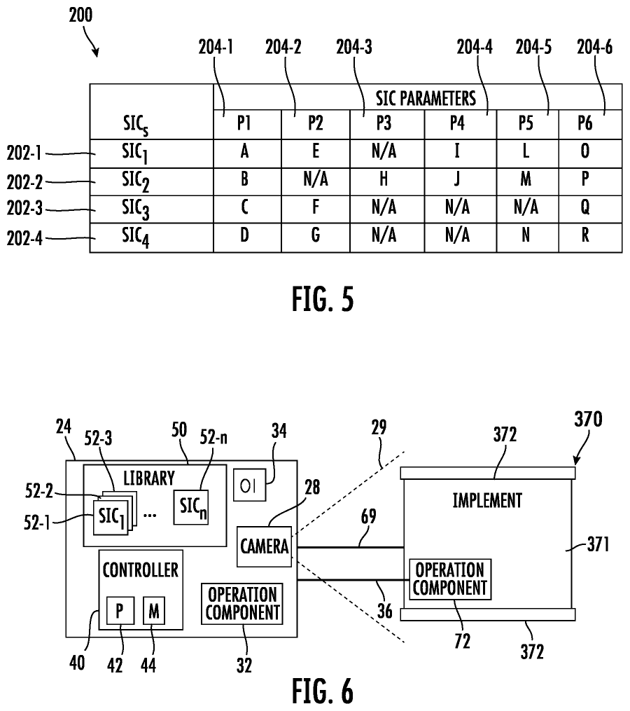

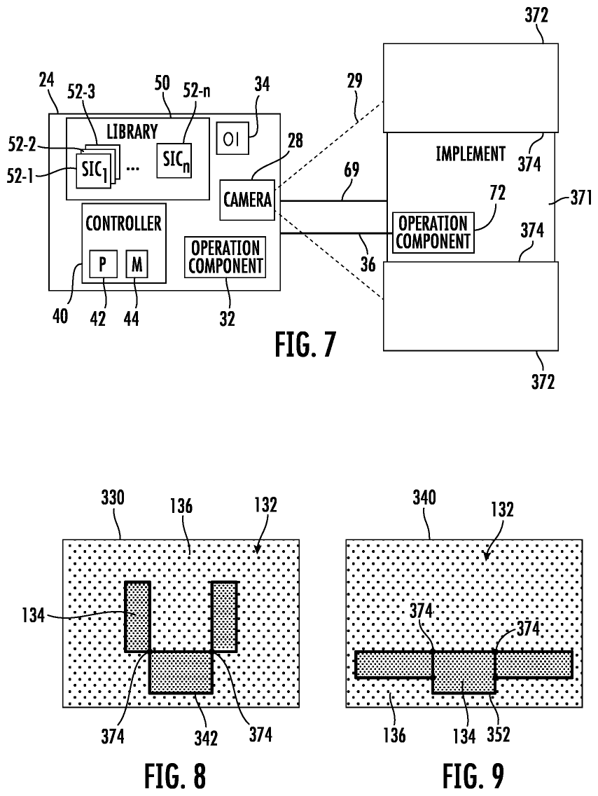

FIG. 6 is a schematic diagram illustrating tractor 24 attached to an example implement 370 having a main portion 371 and actuatable portions 372 in a retracted state. FIG. 7 is a schematic diagram illustrating tractor 24 attached to the example implement 370 having the actuatable portions 372 in an extended state. In the example illustrated, actuatable portions 372 may comprise wings or booms that may pivot relative to main portion 371 about a horizontal axis 374 (shown in FIG. 7) between the retracted state shown in FIG. 6 and the extended state shown in FIG. 7. Examples of implement 372 may include, but are not limited to, a planter, a cultivator, a plow, a disc, a sprayer and the like.

FIG. 8 illustrates an example image 330 of the implement 370 in FIG. 6 taken by camera 28. FIG. 8 further illustrates an example of the aggregation of pixels by controller 40 using optical flow on a series of images during movement of implement 370 while actuation of portion 372 remain in the retracted state. The optical flow analysis used to discern between environmental pixels 136 and implement pixels 134 depicted in a series of images 340 (one of which is shown) may be performed in a fashion similar to as described above with respect to FIGS. 3A-3D or as described above with respect to FIGS. 4A-4D. In particular, implement 370 may be horizontally moved, vertically moved or otherwise moved during the capture of the series of images, wherein the relative positioning and movement of the pixels 132 is digitally analyzed by controller 340 to identify implement pixels 134 and surrounding environment pixels 136.

FIG. 8 further illustrates the identification of the CIC 342 (shown in thick dark lines) from such aggregated pixels as described above with respect to FIGS. 3B-3C or as described above with respect to FIGS. 4B-4C. The CIC 342 may be extracted as described above with respect to FIG. 3D or 4D, wherein the extracted CIC 342 may be compared to an existing library of different SICs as described above. In response to sufficient match of CIC 342 with a particular SIC 52 depicting an implement with actuatable portions in retracted states, controller 40 may identify the candidate implement 370 as being the same type of implement as depicted in the matching SIC and may also identify the implement having actuatable portions 372 in retracted states as also shown by the matching SIC.

FIG. 9 illustrates an example image 340 of the implement 370 in FIG. 7 taken by camera 28. FIG. 8 further illustrates an example of the aggregation of pixels by controller 40 using optical flow on a series of images during movement of implement 370 while actuation of portion 372 remain in the retracted state. The optical flow analysis used to discern between environmental pixels 136 and implement pixels 134 depicted in a series of images 340 (one of which is shown) may be performed in a fashion similar to as described above with respect to FIGS. 3A-3D or as described above with respect to FIGS. 4A-4D. In particular, implement 370 may be horizontally moved, vertically moved or otherwise moved during the capture of the series of images, wherein the relative positioning and movement of the pixels 132 is digitally analyzed by controller 340 to identify implement pixels 134 and surrounding environment pixels 136.

FIG. 9 further illustrates the identification of the CIC 352 (shown in thick dark lines) from such aggregated pixels as described above with respect to FIGS. 3B-3C or as described above with respect to FIGS. 4B-4C. The CIC 352 may be extracted as described above with respect to FIG. 3D or 4D, wherein the extracted CIC 342 may be compared to an existing library of different SICs as described above. In response to sufficient match of CIC 352 with a particular SIC 52 depicting an implement with actuatable portions in extended states, controller 40 may identify the candidate implement 370 as being the same type of implement as depicted in the matching SIC and may also identify the implement re-70 as having actuatable portions 372 in extended states as also shown by the matching SIC.

In the example shown in FIGS. 8 and 9, the instructions in medium 44 are configured to direct the processing resource 42 to determine a state of the candidate implement 370 based upon the comparison of the contour to the stored implement contour. In the example illustrated, the candidate implement 370 has portions movable between a first position and a second position and wherein the state of the candidate implement 370 comprises whether the candidate implement is at the first position or at the second position. In the example illustrated, the candidate implement 370 comprises extendable and retractable wings 372, wherein the first position is a retracted position of the wings (shown in FIG. 8) and wherein the second position is an extended position of the wings (shown in FIGS. 7 and 9). The instruction contained in medium 44 may direct the processing resource 42 to: (1) carry out optical flow on a series of images captured by the camera 28 during movement of a first portion 372 of the candidate implement 370 while a second portion 371 of the candidate implement is stationary; (2) aggregate particular pixels based on relative pixel motion and classifying the particular pixels as belonging to the first portion 372 of candidate implement; (3) determine a movable portion contour based on the particular pixels classified as belonging to the first portion 372; (4) compare the contour and the movable portion contour to a stored implement contour and a stored movable portion contour; and (5) output control signals to adjust operation of at least one of the tractor and the candidate implement based on the comparison.

In some implementations, the instruction contained in medium 44 may direct processing resource 42 to: (1) carry out optical flow on a series of images captured by the camera 28 during movement of a first portion 372 of the candidate implement 370 while a second portion 371 of the candidate implement is stationary; (2) aggregate particular pixels based on relative pixel motion and classifying the particular pixels as belonging to the first portion of candidate implement; (3) determine a movable portion contour based on the particular pixels classified as belonging to the first portion 372; (4) compare the movable portion contour to a stored movable portion contour; (5) determine a state of the first portion 372 of the candidate implement 370 based upon the comparison of the movable portion contour to the stored movable portion contour; and (6) output control signals to adjust operation of at least one of the tractor and the candidate implement 370 based on the determined state of the first portion of the candidate implement 370. In some implementations, this process may be carried out the same way, but wherein the pixels or aggregated and classified as belonging to the second portion 371, wherein the contour of the second portion 371 is determined based on the particular pixels classified as belonging to the second portion and wherein the contour of the second portion is compared to a stored base contour to identify the candidate implement or its state.

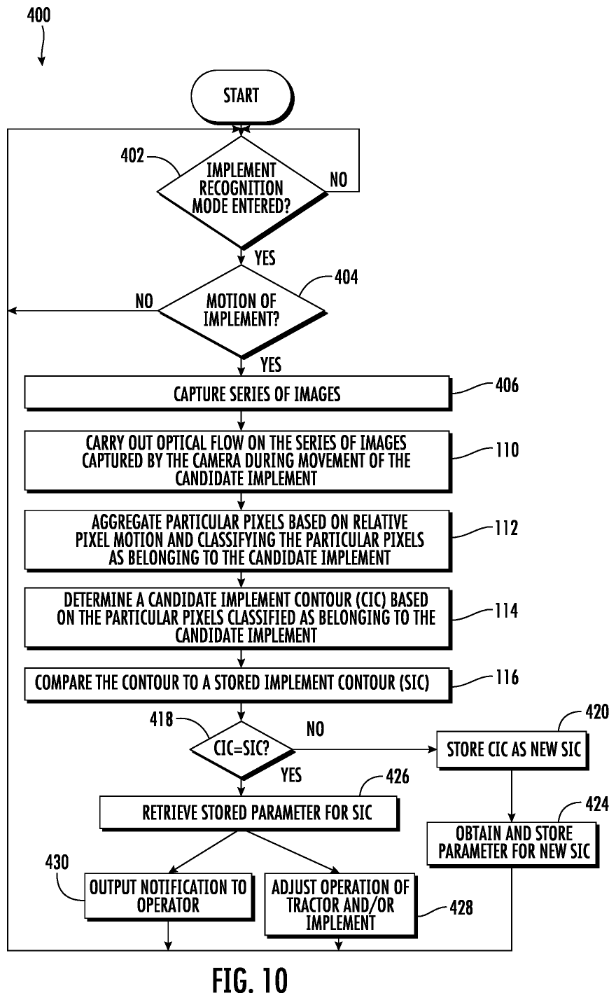

FIG. 10 is a flow diagram of an example automatic implement recognition method 400 carried out by controller 40 as described above. As indicated by block 402, controller 40 determines whether the implement recognition mode has been entered. Controller 40 determines whether or not an operator has requested recognition of an implement currently attached to the tractor. Such input may be made through operator interface 34.

As indicated by block 404, if the implement recognition mode has been entered, controller 40 awaits motion of the implement. As described above, such motion may be initiated by the operator, such as by the operator entering commands via operator interface 34 to drive the tractor to push, pull or carry the implement or such as by the operator entering commands via operator interface 34 to raise or lower the implement, such as with the raising and lowering of a three-point hitch. In some implementations, entry into the implement recognition mode may automatically trigger tractor 24 moving the attached implement in some fashion or may prompt the operator to enter commands or provide input for driving the tractor or raising/lowering the implement.

As indicated by block 406, in response to the tractor being in the implement recognition mode and movement of the implement, controller 40 directs camera 28 to capture a series of images capturing movement of the implement. Such images may be digital in nature and may comprise an array of pixels including both pixels representing the attached implement and environmental pixels.

As indicated by blocks 110, 12, 114 and 116, and as described above, controller 40 may (1) carry out optical flow on the series of images captured by the camera during movement of the candidate implement; (2) aggregate particular pixels based on relative pixel motion and classifying the particular pixels as belonging to the candidate implement; (3) determine a candidate implement contour (CIC) based on the picture pixels classified as belonging to the candidate implement; and (4) compare the contour to a stored implement contour (SIC).

In some implementations, the CIC may include portions of the tractor 24 to which is connected. In such implementations, the SICs may likewise include the same portions of the tractor 24. In some implementations, to facilitate use of an SIC library with different types or versions of practice, both the SICs and any CIC may omit those coupling portions of the tractor. In some implementations, controller 40 may capture images with a camera 28 while the tractor 24 is not attached to an implement. Such captured images will depict those portions of the tractor otherwise used to attach to an implement, such as tractor's drawbar hitch or three-point hitch. Based upon such images, controller 40 may use segmentation or other digital processing techniques on such images to identify the contours of those portions of the tractor that connect to implements. Controller 40 may then perform additional image processing to remove, filter out or subtract those portions of the tractor otherwise used to attach to an implement from either each of the series of images analyzed with optical flow or from the initial CIC which may initially include such portions of the tractor. Once such connection portions of the tractor have been removed, the CIC may be compared to SICs which also omit tractor connections (drawbar hitch, three-point hitch). If no match is found, the CIC, after removal of the tractor connection portions, may be stored as a new SIC. In some implementations, the initial library may be empty, wherein each new CIC does not have a match in the current library such that the library is initially built.

In some implementations, the implement itself is moved relative to the tractor. For example, it may be pivoted about a draw pin while being attached to the drawbar of the tractor. Controller 40 may use optical flow analysis to distinguish between those pixels belonging to the implement and those pixels belonging to the tractor. In such implementations, the contour of tractor portions may be filtered out or removed either from (a) each of the series of images analyzed with optical flow or (b) the initial CIC which may initially include such portions of the tractor.

As indicated by block 416, controller 40 compares the CIC with the SICs 52 in library 50. Controller 40 determines whether the CIC, determined in block 114, sufficiently matches any one of the SICs 52. In some implementations, a CIC may be deemed to sufficiently match a prior SIC in response to the percentage of the number of pixels in the CIC having a location that matches the location of pixels in the SIC exceeding a predefined matching threshold. In some implementations, a CIC may be deemed to sufficiently match a prior SIC in response to no pixels in the CIC being spaced from or distanced from corresponding pixels in the SIC by a distance exceeding a predefined matching distance threshold. In some implementations, controller 40 determines the spacing of each pixel in the CIC from the closest or corresponding pixel in the SIC and determines the percentage of those pixels that are spaced from the closest corresponding respective pixels of the SIC by distance less than a distance threshold. A CIC may be deemed to sufficiently match a prior SIC in response to the percentage of such pixels that satisfy the distance threshold being greater than a predefined percentage. In some implementations, controller 40 may compare the actual shapes of the CIC and SIC, wherein the CIC is deemed to sufficiently match the SIC in response to the two shapes being different by a degree less than a predefined shape matching threshold. In yet other implementations, other techniques may be employed to compare the CIC with each of the SICs to identify sufficient match.

As indicated by blocks 418 and 420, in response to the particular a CIC not matching any of the SICs currently populating library 50, controller 40 stores the particular CIC as a new SIC library 50. As indicated by block 424, controller 40 may also obtain and store at least one parameter associated with the new SIC. In some implementations controller 40 may add a new row for the new SIC in the lookup table 200.

The values for the parameters 204 for populating library 50 and/or lookup table 200 may be acquired in several fashions. In some implementations or operator selected modes, controller 40 may prompt the operator to obtain input values/instructions (described above) for the different parameters. In some implementations or operator selected modes, controller 40 may prompt the operator to enter the name or other identification information for the implement corresponding to the new SIC, wherein controller 40 may use such input to retrieve values for the parameters to be associated with the new SIC from public or private databases in a wireless fashion. For example, controller 40 may access internet-based sources for retrieving recommended values/instructions for the various parameters 204. In some implementations or operator selected modes, controller 40 may automatically search publicly available resources, such as the World Wide Web, to compare the new SIC with the contours of implements depicted on publicly available webpages to identify the new SIC, wherein the values for the parameters 204 are acquired from the particular webpage or associated Internet source that depicted in implement having a contour matching the contour of the new SIC.

As indicated by block 418 and 426, in response to the CIC sufficiently matching a particular SIC 52 in library 50, controller 40 automatically retrieves at least one in each of the stored parameters for the matching SIC. In some implementations, controller 40 may access lookup table 200 and retrieve the values for each of the parameters 204 that are associated with the matching SIC identifier 202.

As shown by blocks 428 and 430, method 400 provides two operator selectable modes. In a first mode, as indicated by block 428, controller 40 may automatically adjust the operation of tractor 24 and/or implements 70 based upon the retrieved values for the at least one parameter in block 426. As described above, such adjustment may comprise adjusting the operational state of the component 32 of tractor 24, adjusting the operational state of operation component 72 of implements 70 and/or adjusting an output of operator interface 34 to provide the operator or those persons or animals not residing on tractor 24, but near tractor 24, with warnings or status information. For example, controller 40 may notify the operator of the particular identified type of implement currently attached tractor 24, may provide the operator with the current width other dimensions of implement 24 or may provide the operator with information based upon the identified type/version/state of the implement attached tractor 24.

Such adjustment may also comprise controller 40 initiating the monitoring of certain conditions of tractor 24/implement 70 or certain components of tractor 24/implement 70, wherein the particular conditions and/or components to be monitored are provided with the particular instructions of parameters 204. In some implementations, particular parameters 204 may identify a particular condition/component for monitoring, wherein the values/instructions (A-R) associated with the different SICs are binary, indicating whether or not the particular condition/component should be monitored for the particular SIC. In some implementations, a parameter may simply indicate general “monitoring”, wherein each of the values (A-R) for the parameters may indicate a different component or condition to be monitored for respective SICs.

In some particular implementations, a battery may be used to provide power to an electric motor for propelling tractor 24. One of the parameters 204 may comprise data regarding the weight of the implement, power consumption by the implement or the rate at which power is consumed to push, pull or carry the implement. Based upon such values retrieved in block 426, controller 40 may retrieve the current remaining battery charge (from a charge sensor) and estimate the remaining time left until the battery is sufficiently drained such that it may no longer provide adequate power for propelling the tractor with the attached implement. Such information may be presented to the operator using text on operator interface 34 (a display screen) which presents a remaining amount of time or remaining distance or via a graphic presented on the screen of operator interface 34, wherein the graphic may depict the remaining amount of time or the remaining distance until the battery is exhausted. Such information may be useful in assisting the operator when planning for the recharging of the battery.

When operating in a second mode, as indicated by block 430, controller 40 does not automatically adjust the operation of the tractor 24 and/or implements 70. Instead, controller 40 outputs a recommendation to the operator, using operator interface 34, and prompts the operator to authorize any recommended adjustments. Upon receiving such authorization the operator interface 34, controller 40 then carries out the recommended adjustments.

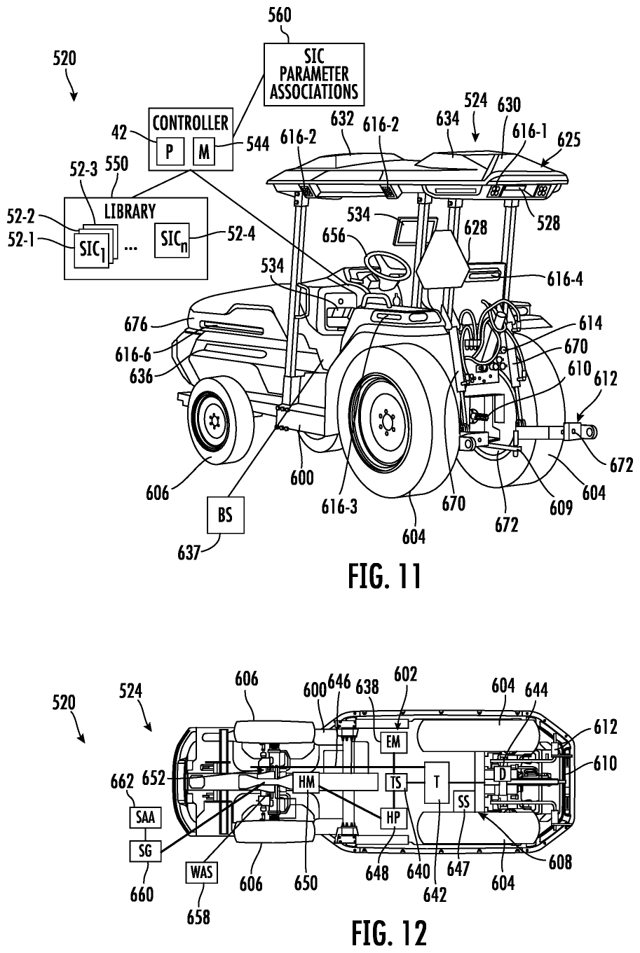

FIGS. 11 and 12 illustrate portions of an example automatic implement recognition system 520, with some portions being schematically illustrated. FIGS. 11 and 12 illustrate one example implementation of system 20 described above. System 520 comprises tractor 524, controller 540, SIC library 550 and SIC parameter associations 560.

Tractor 524 is configured to push, pull or carry an attached implement. Tractor 524 comprises frame 600, propulsion system 602, rear wheels 604, steered front wheels 606, steering system 608, hitch 609, power takeoff 610, three-point hitch 612, hydraulic output couplings 614 and lights 616-1, 616-2, 616-3, 616-4, and 616-6 (collectively referred to as lights 616), camera 528, and operator interfaces 534. Frame 600 comprises a structure which supports the remaining components of tractor 524. Frame 600 supports operator cab 625. Operator cab 625 comprise that portion of tractor 524 in which an operator of tractor 524 resides during use of tractor 522 or. In the example illustrated, operator cab 65 comprises seat 628 and roof 6308628 is beneath roof 630. 600 supports global positioning satellite (GPS) receiver 632 and inertial measurement units 634. Roof 630 further supports camera 528 and some of lights 616.

Propulsion system 602 serves to propel tractor 524 in forward and reverse directions without turning or during turning. Propulsion system 604 comprises battery 636, battery sensor 637, electric motor 638, torque splitter 640, transmission 642, rear differential 644, transaxle 646, speed sensor 647 hydraulic pump 648, hydraulic motor 650 and front wheel transmission 652. Battery 636 comprise one or battery modules which store electrical energy. Battery 636 is supported within an internal battery receiving cavity provided by frame 600. Battery 636 powers the electric motor 638. Battery sensor 637 comprises one or more sensors configured to sense the remaining charge in battery 636 and the electrical power being output by battery 636.

Electrical motor 638 (schematically illustrated) outputs torque which is transmitted by a gearing to torque splitter 640. Torque splitter 640 transmits torque to transmission 642 and to hydraulic pump 648. Transmission 642 provides a plurality of forward and reverse gears providing different rotational speeds and torques to the rear wheels 604. Transmission 642 further supplies torque to power takeoff 610. Differential 644 comprise a set of driveshafts that cause the rotational speed of one shaft to be the average of the speeds of the other shafts or a fixed multiple of that average.

Transaxle 646 extends from transmission 642 and transmits torque to front wheel transmission 652 for rotatably driving wheels 606. Speed sensors 647 output signals indicating the forward or reverse speed of wheel 604 and of tractor 524. Hydraulic pump 648 supplies pressurized fluid to three-point hitch 612 and hydraulic output couplings 614. Hydraulic pump 648 further supplies pressurized fluid to drive hydraulic motor 650. Hydraulic motor 650 supplies torque to front wheel transmission 652. This additional torque facilitates the rotatable driving of front wheels 606 at speeds that proportionally differ than the rotation speeds at which rear wheels 604 are being driven by transmission 642.

Steering system 608 controls steering of front wheels 606 to control the course of tractor 524. In some implementations, steering system 608 may comprise a steer by wire system which comprises steering wheel 656, wheel angle sensors 658, steering gears 660 and steering angle actuator 662. Steering wheel 656 serves as an input device by which an operator may turn and steer front wheels 606. In the example illustrated, steering wheel 656 is provided as part of tractor 524 within operator cab 625. In other implementations, tractor 524 may omit cab 625, seat 628 or steering wheel 656, wherein steering wheel 656 may be provided at a remote location and wherein signals from manipulation of the steering wheel are transmitted to a controller on tractor 524 in a wireless fashion. The angular position of steering wheel 656 may correspond to or may be mapped to an angular position of the steered front wheels 606. In some implementations, tractor 524 is configured to be steered in an automated fashion by controller 540 according to a sensed surroundings received by controller 540 from various cameras or sensors provided on tractor 524 and/or according to a predefined steering routine, route or path based upon signals from GPS 632 and/or inertial measurement units 634.

Wheel angle sensor 658 comprises one or more sensors, such as potentiometers or the like, that sense angular positioning or steering angle of front wheels 606. Steering gears 660 comprise gears or other mechanisms by which front wheels 606 may be rotated. In some implementations, steering gears 60 may comprise a rack and pinion gear arrangement. Steering angle actuator 662 comprise an actuator configured to drive steering gears 660 so as to adjust the angular positioning of front wheels 606. In some implementations, steering angle actuator 662 comprises an electric motor or hydraulic motor (powered by a hydraulic pump).

Hitch 609 comprise a bar rearwardly projecting from frame 600 and configured to be releasably connected to an implement. Hitch 69 may comprise an opening configured to receive a pin which is also concurrently received within an opening of an implement drawbar. In some implementations, hitch 69 may comprise a hitch ball or other connection components.

Power takeoff 610 comprises a splined shaft or other coupling which may receive torque from transmission 642 and which may supply torque to an implement attached to tractor 524. Three-point hitch 612 may comprise jacks 670 (hydraulic cylinder-piston assemblies) which receive pressurized hydraulic fluid from hydraulic pump 648 and which may be selectively extended and retracted by a valving system to selectively raise and lower lift arms 672 which may be connected to an attached implement to raise and lower the attached implement. Hydraulic output couplings 614 receive hydraulic pressure from hydraulic pump 648 (or another hydraulic pump provide on tractor 524) and supply pressurized hydraulic fluid (via connected hydraulic hoses) to hydraulically powered components of an attached implement. Coupling 614 may be associated with a hydraulic manifold and valving system to facilitate control over the hydraulic pressure supplied to such coupling 614.

Lights 616 provide illumination for regions about tractor 524. Lights 616-1 and 616-4 provide illumination at a rear of tractor 524, enhancing images captured by camera 528. Lights 616-1 are supported by roof 630 and face in a rearward direction. Lights 616-4 are supported below roof 630, behind seat 628 and face rearward. Lights 616-2 are supported by roof 630 and face in sideways directions. Lights 616-6 are supported on a hood portion 676 of tractor 524 along the sides in front of the hood portion 676. Lights 616 provide illumination along a front and sides proximate to front wheel 606. Each of such lights may be under the control of controller 540 and may be actuatable between different states (colors, intensities, flashing frequencies) to provide visible notifications or alerts to those not residing on tractor 524, but about tractor 524.

Camera 528 is supported by roof 630 and faces in a rearward and downward direction so as to have a field-of-view configured to encompass different implements that may be attached to tractor 524, that may be connected to hitch 609, power takeoff 610, hydraulic output couplings 614 and/or three-point hitch 612. Cameras 528 may comprise a monocular/2D camera or may comprise a stereo/3D camera. Camera 528 may be configured to capture still images and/or video. In the example illustrated, tractor 524 comprise additional cameras situated along and about roof 630, facing in forward and sideways directions.

Operator interfaces 534 are similar to operator interface 34 described above. Operator interfaces 504 facilitate the provision of information to an operator and the input of commands/information from an operator. In the example illustrated, operator interfaces 534 are in the form of a touchscreen monitor, a console having pushbuttons, slider bars, levers and the like, and a manually manipulable joystick.

Controller 540 is similar to controller 40 described above. Controller 540 comprises a processor 42 and a memory 544. Memory 544 comprises a non-transitory computer-readable medium containing instructions configured to direct processor 42 to carry out method 100 and/or method 400 described above. Controller 540 is configured to communicate with or access SIC library 550. SIC library 550 is similar to library 50 in that it contains SICs 52. Each of the SICs 52 in library 550 may be associated with an SIC identifier and associated parameters provided as SIC parameter associations 560. In some implementations, the SIC parameter associations 560 may be in the form of a lookup table, similar to table 200 in FIG. 5.

As discussed above, controller 540 may reside on tractor 524, may be remote from tractor 524 or may portions that are both on tractor 524 and remote from tractor 524. Likewise, library 550 and SIC parameter associations 560 may be stored on tractor 524, may be stored remote from tractor 524 or may have portions stored on tractor 524 and portion stored remote from tractor 524. In implementations where controller 540 is remote from tractor 524, controller 540 may communicate with a local controller on tractor 524 in a wireless fashion. Likewise, in implementations where library 550 and/or associations 560 are remote from tractor 524, controller 540 or another controller on tractor 524 may communicate with a remote server that provides access to library 550 and/or associations 560.

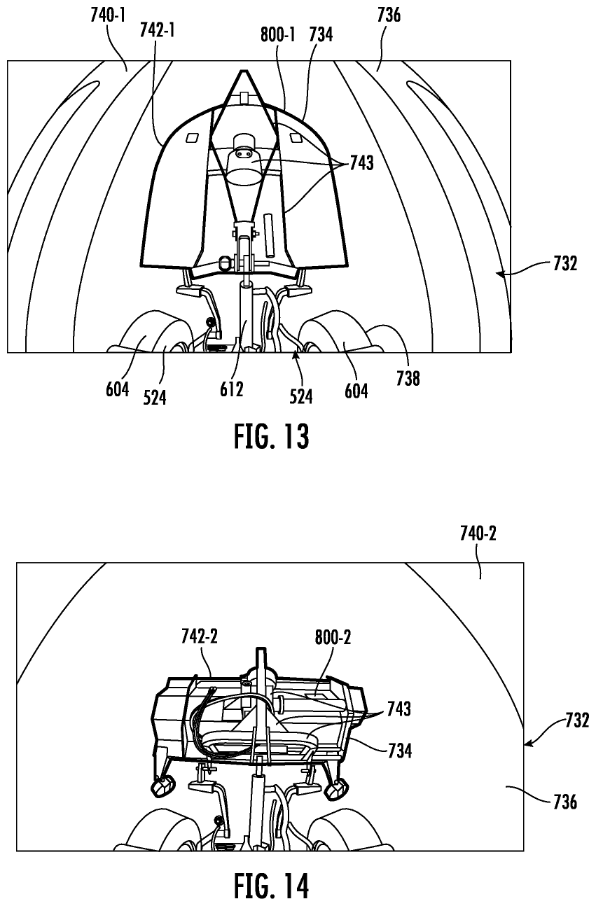

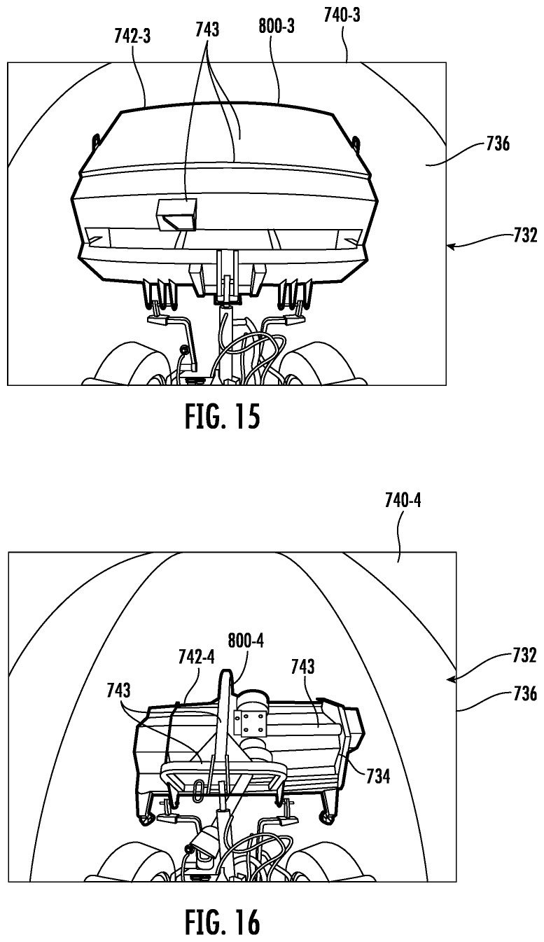

FIGS. 13-16 illustrate examples of images of various implements captured by a camera, such as camera 582 of a tractor, such as tractor 524, wherein the pixels or pixel groups have been aggregated and classified as the candidate implement based upon optical flow analysis of a series of images during movement of the implement and wherein candidate implement contours have been determined. As described above, once the candidate implement contour has been determined, may be extracted from the image and compared to prior SIC 52 to identify the particular candidate implement and to further determine what actions occasions should occur in response to the match. As described above, if no match is found, the candidate implement contour may be saved as a new SIC for use in later comparisons to subsequent CICs.

FIG. 13 provides an example image 740-1 captured by camera 528 of tractor 524. Image 540-1 comprises a digital image having pixels 532 that comprise example implement pixels 534, example environment pixels 536 and example tractor pixels 538. The example implement pixels 534 are those of an example implement 800-1 in the form of an example seeder. The example environment pixels 536 depict vine rows along and between which the implement 800-1 is being towed by tractor 524, partially depicted by tractor pixels 738. Tractor pixels 738 depict the rear wheel 604 and the three-point hitch 612 of tractor 524.

As described above, controller 540 (or controller 40) receives a series of images from camera 528 during movement of implement 800-1. Controller 540 may (1) carry out optical flow on the series of images captured by the camera 528 during movement of the candidate implement 800-1; (2) aggregate particular pixels 734 based on relative pixel motion and classifying the particular pixels 734 as belonging to the candidate implement 800-1; (3) determine a candidate implement contour (CIC) 742-1 based on the picture pixels classified as belonging to the candidate implement 800-1; and (4) compare the CIC 742-1 to the SICs 52 contained in library 550.

In some implementations, the identification of a group or aggregation of pixels as depicting a candidate implement may additionally be based upon the size of the aggregation of pixels and the relative positioning of such aggregated pixels in the image. For example, and aggregation of pixels centered in the image may be determined to be that of a candidate implement based on the presumption that the candidate implement is attached to the tractor and is centered along the longitudinal axis of the tractor with the camera also adding a field-of-view also centered along the longitudinal axis of the tractor.

In some implementations, the CIC 742 comprises the outermost outer perimeter of the implement, the boundary between those pixels that moved in unison during movement of implement 800-1 and those pixels that moved relative to the group of pixels that did not move relative to one another. In some implementations, the CIC and the SICs may additionally comprise interior lines or shapes 743 formed by differences in pixel intensities or colors and discerned by controller 540. Such additional shapes or line 743 may facilitate more precise matching of a candidate implement to a particular SIC contained in library 550.

In some implementations, the CIC may include portions of the tractor 24 to which is connected. As shown by FIG. 13, image 740-1 includes pixels depicting portions of tractor 524. In such implementations, the SICs may likewise include the same portions of the tractor 524. In some implementations, controller 540 compares a candidate implement contour, including portions of the attached tractor, to SICs which also include portions of the same tractor.

In some implementations, to facilitate use of an SIC library with different types or versions of practice, both the SICs and any CIC may omit those coupling portions of the tractor. In some implementations, controller 540 may capture images with a camera 528 while the tractor 524 is not attached to an implement. Such captured images may depict those portions of the tractor otherwise used to attach to an implement, such as tractor's drawbar hitch or three-point hitch. Based upon such images, controller 40 may use segmentation or other digital processing techniques on such images to identify the contours of those portions of the tractor that connect to implements. Controller 540 may then perform additional image processing to remove, filter out or subtract those portions of the tractor otherwise used to attach to an implement from either each of the series of images analyzed with optical flow or from the initial CIC which may initially include such portions of the tractor. Once such connection portions of the tractor have been removed, the CIC may be compared to SICs which also omit tractor connections (drawbar, three-point hitch). If no matches found, the CIC, after removal of the tractor connection portions, may be stored as a new SIC. In some implementations, the initial library may be empty, wherein each new CIC does not have a match in the current library such that the library is initially built.

In some implementations, the implement itself is moved relative to the tractor. For example, it may be pivoted about a draw pin while being attached to the drawbar of the tractor. Controller 540 may use optical flow analysis to distinguish between those pixels belonging to the implement and those pixels belonging to the tractor. In such implementations, the contour of tractor portions may be filtered out or removed either from (a) each of the series of images analyzed with optical flow or (b) the initial CIC which may initially include such portions of the tractor.

As discussed above, controller 540 compares the CIC with the SICs 52 in library 50. Controller 40 determines whether the CIC sufficiently matches any one of the SICs 52. In some implementations, a CIC may be deemed to sufficiently match a prior SIC in response to the percentage of the number of pixels in the CIC having a location that matches the location of pixels in the SIC exceeding a predefined matching threshold. In some implementations, a CIC may be deemed to sufficiently match a prior SIC in response to no pixels in the CIC being spaced from or distanced from corresponding pixels in the SIC by a distance exceeding a predefined matching distance threshold. In some implementations, controller 40 determines the spacing of each pixel in the CIC from the closest or corresponding pixel in the SIC and determines the percentage of those pixels that are spaced from the closest corresponding respective pixels of the SIC by distance less than a distance threshold. A CIC may be deemed to sufficiently match a prior SIC in response to the percentage of such pixels that satisfy the distance threshold being greater than a predefined percentage. In some implementations, controller 540 may compare the actual shapes of the CIC and SIC, wherein the CIC is deemed to sufficiently match the SIC in response to the two shapes being different by a degree less than a predefined shape matching threshold. In yet other implementations, other techniques may be employed to compare the CIC with each of the SICs to identify sufficient match.

Upon identifying a particular SIC that matches the candidate CIC, controller 540 accesses SIC parameter associations 560. Controller 540 may determine which parameter values/instructions are associated with the matching SIC. As described above with respect to block 428 of method 400, controller 540 may automatically adjust operational settings for tractor 524 or operational settings for implement 800-1. Controller 540 may additionally or alternatively begin monitoring certain conditions or components of tractor 524 and/or implement 800-1 based upon the monitoring instructions found in the parameter associations 560 for the matching SIC. Such monitoring instructions may not only identify what components or conditions are to be monitored, but may also identify particular thresholds and particular actions, such as adjustments and/or operator alerts, that are to be made upon such thresholds being satisfied.

As described above with respect to block 430 of method 400, controller 540 may alternatively provide the operator with a notification of a recommended adjustment or the recommendation to begin monitoring a certain component and such or condition, wherein controller 540 holds off on executing such adjustments or monitoring actions until receiving authorization input from the operator.

The values of such parameters found in the SIC parameter associations 560 may prescribe certain operational settings for the tractor 524 such as: a power takeoff speed or range of power takeoff speeds for power takeoff 610; a hydraulic coupling output pressure or range of hydraulic coupling output pressures for coupling 614; a three-point hitch height or range of three-point hitch heights or three-point hitch 612; and guardrail safety distance. The parameter 204 associated with the matched SIC or its identifier may additionally or alternatively call for one or more operational settings of the tractor 524 selected from a group of operational settings consisting of: steering of the tractor 524 by controller 540 and speed of the tractor 524 by controller 540. Based upon the steering or speed prescriptions, controller 540 may output control signals adjusting the operation of electric motor 638, hydraulic pump 648, hydraulic motor 650 and/or steering angle actuator 662. The parameter may indicate that particular ones of light 616 should be illuminated or with what intensity or brightness such lights should be illuminated.

In some implementations, one or more of the parameters of associations 560 may pertain to different values associated with the implement 800-1. For example, in some implementations, a particular parameter may pertain to the width of implement 800-1. In other implementations, the parameter may pertain to the height of implement 800-1. In some implementations, the parameter may pertain to the weight or towing demands of implement 800-1. Such values may be used by controller 540 to determine an operational setting of tractor 524 or the interaction of tractor 524 with implement 800-1 in response to a particular type/version/state of the particular implement attached to tractor 524. For example, in some implementations, the identified width of implement 800-1 may be used by controller 540 to output steering commands to tractor 524 to appropriately locate tractor 524 and the particular attached implement 800-1 when implement 800-1 is being parked or stored, when implement 800-1 is interacting with the ground or plants, or when implement 800-1 is being pushed, pulled or carried between plant rows.

In some circumstances, the parameter of parameter associations 560 may call for controller 540 to monitor particular components of tractor 524 or of implement 800-1 or states/conditions of tractor 524 implement 800-1. For example, with some implementations, it may be beneficial to monitor or track particular components or conditions whereas with other implements, it may be beneficial to monitor or track other particular components or conditions. The identification of the type, version and/or state of the implement 800-1 may assist in determining what provided sensors on tractor 524 should be activated or polled or what sensors on implement a non-1 should be activated or polled.

For example, the parameter may indicate what components or conditions of tractor 524 should be monitored with one or more sensors provided on tractor 524. The parameter may indicate what components and such or conditions of implement 800-1 should be monitored with one or more sensors provided on implement 800-1 and in communication with controller 540. Examples of such sensors include cameras, pressure sensors, force sensors and the like.

FIGS. 14, 15 and 16 depict images 740-2, 740-3 and 740-4, respectively, captured by camera 528 of tractor 524. Image 740-2 comprises pixels 732 depicting an implement 800-2 in the form of a flail mower, during movement of implement 800-2. Image 740-3 comprises pixels 732 depicting an implement 800-3 in the form of a rotary mower, during movement of the implement 800-3. Image 740-4 comprises pixels 732 depicting an implement 800-3 in the form of a second version of a flail mower, different than the version of the flail mower shown in FIG. 14, during movement of the implement 800-4.

As shown by such figures, controller 540 may carry out the same process described above with respect to FIG. 13 and image 740-1, and as described above with respect to methods 100 and 400, to determine a candidate implement contour 742 shown in dark thicker boundary lines. As shown by FIG. 13-16, implements 800-1, 800-2, 893 and 800-4 have unique contours 742-1, 742-2, 742-3 and 742-4, respectively. Likewise, in some implementations, such CICs may additionally comprise internal lines or shapes 743 to facilitate or precise matching of the CIC with SICs to provide more precise implement identification. The particular CIC 742 may be added to library 550 if no matches found. If a match is found, controller 540 may carry out adjustment or operations pursuant to the parameters found in SIC parameter associations 563 each of the different respective implements 800.

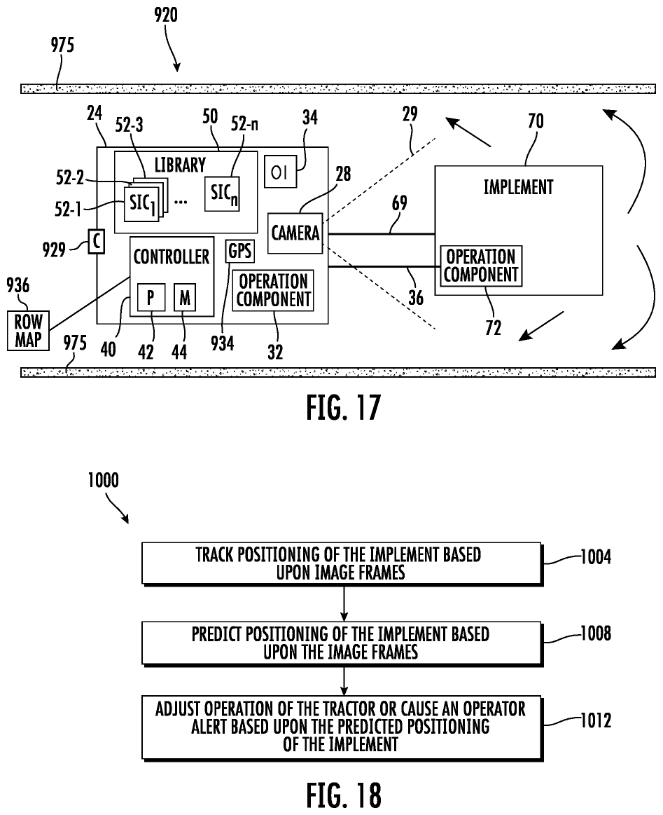

FIG. 17 is a diagram schematically illustrating portions of an example vision safety system or implement tracking and control system 920. System 920 is configured to automatically identify circumstances where a footprint of an implement is about to travel across a determined boundary (sometimes referred to as safety guard rails) which may result in damage to the implement, which may result in damage to plants of a field, vineyard or orchard, or which may result in damage or injury to other structures or persons. System 920 is similar to system 20 described above except that system 20 additionally comprises forward camera 929, global positioning satellite (GPS) 934, row map 936 and memory 944. Those remaining components of system 920 which correspond to components of system 20 are numbered similarly.

Forward camera 929 may comprise a stereo (three-dimensional) camera carried by vehicle 24 on a forward facing a front of vehicle 24. Camera 929 is configured to capture images of regions in front of vehicle 24 as vehicle 24 is traveling in a forward direction.

GPS 934 comprises a GPS receiver configured to receive signals from a satellite system and output signals which may be utilized by controller 40 to determine the geographic coordinates of vehicle 24, and of the pulled or carried implement 70.

Row map 936 comprises a digital map identifying the geographic coordinates of plant rows. The geographic coordinates of such plant rows may have been previously determined based upon prior planting, tillage or other prior agronomy operations during travel across a field, orchard or vineyard. The geographic coordinates of such plant rows may have been previously determined based upon aerial photographs. In the example illustrated, vehicle 24 is illustrated as pulling or carrying implement 70 between a pair of consecutive plant rows 975. Such plant rows may constitute boundaries which are not to be infringed by movement of tractor 24 or implement 70 as tractor 24 pulls or carries implement 70 along and between plant rows 975.

Memory 944 is similar to memory 44 in that memory 944 may contain instructions for directing processor 42 to carry out or perform methods 100 and/or 400 as described above. As described above, method 100 and/or 400 determine a contour or a footprint of an implement based upon a series of images captured by camera, such as camera 28. As described above, in carrying out method 100 and/or method 400, controller 40 may (1) carry out optical flow on a series of images captured by the camera during movement of the implement; (2) aggregate particular pixels based on relative pixel motion and classifying the particular pixels as belonging to the implement; and (3) determine the implement contour based on the particular pixels classified as belonging to the implement. As described above, in some implementations, the identification of the contour of the implement permits controller 40 to further identify the type of implement currently being pulled or carried by vehicle 24 or the current state of the implement currently being pulled or carried by vehicle 24. Controller 40 may output control signals adjusting the state or operation of an operation component 32 of vehicle 24 or of operation propulsion 72 of implement 70 based upon the determined type of implement or its current state.

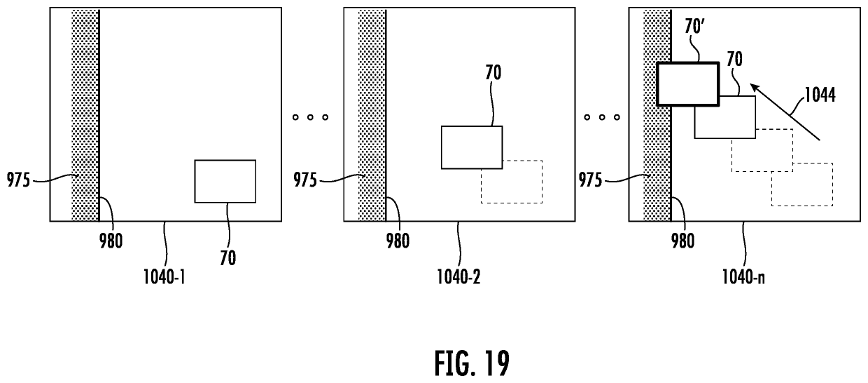

The instructions contained in memory 944 further facilitate the tracking of movement of implement 70. The instructions in memory 944 are configured to direct processor 42 to carry out the example implement tracking and control method 1000 shown in FIG. 18 and schematically depicted in FIG. 19. As indicated by block 1004 in FIG. 18, controller 40 tracks the positioning of implement 70 based upon image frames captured by camera 28.

FIG. 19 illustrates a series of example image frames 1040-1, 1040-2, . . . 1040-n (collectively referred to as frames 1040) captured by camera 28. Each of frames 1040 depicts implement 70 (or a movable portion of implement 70) (schematically illustrated). As shown by FIG. 19, at the different times at which the different image frames 1040 are captured by camera 28, implement 70 is at a new or different position within the field-of-view of camera 28 or relative to camera 28.

In such example implementations, controller 40 may determine the footprint of the implement from the identified implement contour as described above. The implement's footprint may be determined using optical flow approach. When the vehicle or tractor is in motion, both the implement and the tractor frame have similar motion with respect to background as implement is attached to the tractor. Those pixels of images of the implement and tractor frame are aggregated to identify the footprint/contour/contour of the tractor and the footprint of the implement. The prior positions of implement 70 do not actually appear in such images, but are shown in broken lines for purposes of illustration.

In the example illustrated, controller 40 may utilize method 100 or method 400 to additionally determine the contour or footprint of implement 70 (shown by the depicted boundary, schematically shown as a rectangle). As indicated by block 1008 in FIG. 18, controller 40 predicts a future forthcoming position of implement 70 based upon the changes in positioning of implement 70 or its contour/footprint in the image frames. Based upon the time-lapse between the capture of images 1040 or the frequency of such images 1040, controller 40 may also determine a rate at which implement 70 is moving. In particular, controller 40 may determine changes in the different positions between and amongst the different image frames 1040 to determine a geographic positioning rate of change of implement 70 corresponding to the movement of implement 70 as indicated by arrow 1044. Although the example images 1040 depict linear translation of implement 70, in other circumstances, implement 70 may have a curved or rotational movement (as shown in FIG. 17). In the example illustrated, the predicted future positioning of implement 70 or the future projected positioning of the contour/footprint of implement 70 is overlaid upon image 1040-n and identified with reference 70′.

As indicated by block 1012 in FIG. 18, controller 40 may adjust the operation of the vehicle 24 (a tractor) or cause the output of an operator alert (using operator interface 34) based upon the predicted positioning 70′ of the implement 70. For example, controller 40 may adjust the speed at which vehicle 24 is being driven or may adjust the steering of vehicle 24. Controller 40 may output control signals to an actuator which shifts a transmission or changes the output of electric motor or internal combustion engine. Controller 40 may output control signals to an actuator of a steer by wire system which adjusts a steering gear (such as a rack and pinion gear) to adjust the angle of forward wheels or traction members to adjust such steering. Such control signals may change the future predicted positioning of implement 70.

As further shown by FIG. 19, in some implementations, controller 40 may compare the predicted positioning of the implement to a boundary 980 and output control signals adjusting operation of the vehicle/tractor 24 and/or implement 70, or causing the operator alert on operator interface 34 to be triggered in response to the predicted positioning of the implement infringing the boundary 980. In some implementations, the boundary 980 may comprise an edge of a plant row, such as plant row 975 or a line corresponding to plant roots or stems. In some implementations, the boundary 980, serving as a guide rail, may be spaced from the edge of the plant row 975, towards implement 70, by a predetermined distance to provide a cushion or tolerance zone to further reduce the likelihood of implement 70 impinging the plant row.

In some implementations, controller 40 may determine the path boundary 980 for the implement 70. The path boundary 980 may correspond to plant rows of a vineyard, orchard or crop field, wherein crossing of such boundaries by the implement may result in damage to the plant rows. The path boundary 980 may be determined based upon images received from various 2D and/or 3D cameras or other sensors (lidar sensors) carried by the tractor and/or implement, such as forward camera 929. For example, the boundary or boundary layer may be determined using a front stereo camera 929 which may provide both two-dimensional (RGB) and three-dimensional point cloud information. Computer vision and deep learning techniques (machine learning) may be utilized to identify and determine the stems (roots) of plant rows 975, wherein such stems on the same plant liner joined to identify a crop or plant line which serves as a boundary layer 980. This boundary layer 980 serves as a barrier layer across which the implement 70 should not pass.

In some implementations, the boundary 980 may be determined based upon signals from GPS 934 and row map 936. Signals from GPS 934 may be utilized by controller 40 to determine the geographic positioning of vehicle/tractor 24 and the pulled implement 70. Row map 936 may be consulted by controller 40 to determine the geographic coordinates of plant rows 975. Using the current geographic positioning of vehicle/tractor 24 and the predetermined positioning of plant rows 975 from row map 936, controller 40 may determine the geographic coordinates of boundary 980 and/or the current spacing between the periphery of implement 970 and boundary 980.

In the example illustrated, controller 40 may be configured to determine a current rate of movement of the implement based upon the images and times at which the images were captured by the camera 28 and predict a current estimated time of infringement of the boundary by the implement based upon the current rate of movement of the implement 70. In such an implementation, controller 40 may be configured to adjust a speed of the vehicle/tractor 24 and/or a degree of a steering adjustment for the vehicle/tractor 24 based upon the predicted current estimated time of infringement of the boundary by the implement. For example, in circumstances where implement 70 is determined to be moving at a high speed towards a boundary 980, controller 40 may output control signals causing vehicle 24 to be slowed down at a faster rate or to be turned at a faster rate as compared to circumstances where implement 70 is slowly moving towards the boundary 980.

Although method 1000 is described with respect to system 920 and vehicle/tractor 24, in other implementations, system 520 and its tractor 524 may likewise be configured to additionally or alternatively provide implement tracking and control. Instructions in memory 544 may be configured to direct processor 42 to additionally carry out method 1000 as described above and schematically illustrated in FIG. 19. In some implementations, system 520 or system 920 may be configured to carry out method 1000 based upon a predefined or input contour footprint of implement 70, without necessarily calculating or determining the contour or footprint of implement 70 based upon a flow analysis of images received from camera 28.

Although the above disclosure describes the automatic implement recognition system in the context of a tractor which pushes, pulled or carries an implement, the automatic implement recognition system may likewise be carried out with any vehicle that pushes, pulled or carries an implement or attachment. The above-described methods may likewise be carried out to identify the states positioning of selected movable portions of a vehicle, such as movable portions of a tractor, harvester, sprayer or the like, independent of whether any implements are attached to the vehicle. For example, a controller may carry out optical flow on a series of images captured by a camera during movement of a movable portion of a vehicle, aggregate particular pixels based on the relative pixel motion and classifying the particular pixels as belonging to the movable portion of the vehicle. Based on the particular pixels classified as belonging to the movable portion of the vehicle, the controller may determine a contour of the movable portion of the vehicle, wherein the contour may correspond to a particular state or positioning of the movable portion. By comparing the determined contour of the movable portion to a library of stored contours of the same movable portion at different positions are different states, the controller may determine the particular position or state of the movable portion of the vehicle and may output control signals to adjust operation of the vehicle and/or the movable portion based upon the comparison.

Although the claims of the present disclosure are generally directed to determining the contour and/or footprint of an implement based upon a series of captured images, the present disclosure is additionally directed to use of the determined contour. Such uses include (1) identifying the particular type of implement attached to the tractor, based upon the determined contour/footprint, to adjust operation of the tractor and/or implement and/or (2) tracking movement of the implement's footprint/contour to determine potential infringement of a boundary by movement of the implement into or across a guide rail or boundary. Examples of such implementations and uses are set forth in the following definitions.
Definition 1. An automatic implement recognition system comprising:
   a tractor;
   a camera mounted to the tractor and having a field-of-view configured to encompass a candidate implement that is attached to the tractor;
   a processing resource;
   a non-transitory computer-readable medium containing instructions configured to direct the processing resource to:
   carry out optical flow on a series of images captured by the camera during movement of the candidate implement;
   aggregate particular pixels based on relative pixel motion and classifying the particular pixels as belonging to the candidate implement;
   determine a candidate implement contour based on the particular pixels classified as belonging to the candidate implement;
   compare the contour to a stored implement contour; and
   output control signals to adjust operation of at least one of the tractor and the candidate implement based on the comparison.
Definition 2. A non-transitory computer-readable medium containing instructions configured to direct a processing resource to:
   carry out optical flow on a series of images captured by the camera during movement of the candidate implement;
   aggregate particular pixels based on relative pixel motion and classifying the particular pixels as belonging to the candidate implement;
   determine a candidate implement contour based on the particular pixels classified as belonging to the candidate implement; and
   compare the contour to a stored implement contour; and output control signals to adjust operation of at least one of the tractor and the candidate implement based on the comparison.
Definition 3. An automatic implement recognition method comprising:
   carrying out optical flow on a series of images captured by the camera during movement of the candidate implement;
   aggregating particular pixels based on relative pixel motion and classifying the particular pixels as belonging to the candidate implement;
   determining a candidate implement contour based on the particular pixels classified as belonging to the candidate implement;
   comparing the contour to a stored implement contour; and
   outputting control signals to adjust operation of at least one of the tractor and the candidate implement based on the comparison.
Definition 4. An implement tracking and control system comprising:
   a vehicle configured to pull or carry an implement;
   a camera carried by the vehicle configured to output image frames depicting the implement during movement of the implement; and
   a controller configured to:
      track positioning of the implement based upon the image frames;
      predict positioning of the implement based upon the image frames; and
      output control signals adjusting operation of the tractor or causing an operator alert based upon the predicted positioning of the implement.
Definition 5. The system of Definition 4, wherein the controller is further configured to compare the predicted positioning of the implement to a boundary and wherein the output of the control signals adjusting operation of the tractor or causing the operator alert is triggered in response to the predicted positioning of the implement infringing the boundary.
Definition 6. The system of Definition 5, wherein the boundary comprise a plant row.
Definition 7. The system of Definition 6, wherein the camera faces in a rearward direction towards the implement, the system further comprising a second camera facing in a forward direction, wherein the controller is configured to determine the boundary based upon images captured by the second camera.
Definition 8. The system of Definition 6 further comprising a global positioning satellite (GPS) system carried by the vehicle and a map of plant rows including the plant row, wherein the controller is configured to determine the boundary based upon a current position of the vehicle using signals from the GPS system and the map of plant rows.
Definition 9. The system of Definition 4, wherein the adjusting of the operation of the tractor comprises adjusting a speed and/or adjusting a steering of the tractor.
Definition 10. The system of Definition 4, wherein the controller is configured to:
determine a current rate of movement of the implement based upon the images and times at which the images were captured by the camera; and
predict a current estimated time of infringement of the boundary by the implement based upon the current rate of movement of the implement.
Definition 11. The system of Definition 10, wherein the controller is configured to adjust a speed of the tractor and/or a degree of a steering adjustment for the tractor based upon the predicted current estimated time of infringement of the boundary by the implement.
Definition 12. The system of any of Definitions 4-11, wherein the controller is configured to adjust a state of the implement based upon the predicted positioning of the implement.
Definition 13. The system of any of Definitions 4-12, wherein the controller is configured to track positioning of an implement contour or an implement footprint and predict positioning of the implement contour or implement footprint of the implement based upon the image frames.
Definition 14. The system Definition 13, wherein the controller is configured to:
carry out optical flow on a series of images captured by the camera during movement of the implement;
   aggregate particular pixels based on relative pixel motion and classifying the particular pixels as belonging to the implement;
determine the implement contour based on the particular pixels classified as belonging to the implement.

Although the present disclosure has been described with reference to example implementations, workers skilled in the art will recognize that changes may be made in form and detail without departing from the scope of the claimed subject matter. For example, although different example implementations may have been described as including features providing benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. An automatic implement recognition system comprising:
a tractor;
a camera mounted to the tractor and having a field-of-view configured to encompass a candidate implement that is attached to the tractor;
a processing resource;
a non-transitory computer-readable medium containing instructions configured to direct the processing resource to:
carry out optical flow on a series of images captured by the camera during movement of the candidate implement;
aggregate particular pixels based on relative pixel motion and classifying the particular pixels as belonging to the candidate implement;
determine a candidate implement contour based on the particular pixels classified as belonging to the candidate implement;
compare the contour to a stored implement contour; and
output control signals to adjust operation of at least one of the tractor and the candidate implement based on the comparison.

2. The automatic implement recognition system of claim 1, wherein the instructions are further configured to direct the processing resource to:
save the candidate implement contour as a second stored implement contour in response to the candidate implement contour differing from the stored implement contour.

3. The automatic implement recognition system of claim 2, wherein the instructions are further configured to direct the processing resource to associate a parameter of the candidate implement with the second stored implement contour.

4. The automatic implement recognition system of claim 3, wherein the parameter comprises a width of the candidate implement.

5. The automatic implement recognition system of claim 3, wherein the parameter comprises an operational setting for the candidate implement.

6. The automatic implement recognition system of claim 3, wherein the parameter comprises an operational setting for the tractor.

7. The automatic implement recognition system of claim 6, wherein the operational setting for the tractor is selected from a group of operational settings for the tractor consisting of: a power takeoff speed or range of power takeoff speeds; a hydraulic coupling output pressure or range of hydraulic coupling output pressures; a three-point hitch height or range of three-point hitch heights; and PTO RPM limits.

8. The automatic implement recognition system of claim 1, wherein the control signals are configured to adjust an operational setting for the tractor.

9. The automatic implement recognition system of claim 8, wherein the operational setting for the tractor is selected from a group of operational settings for the tractor consisting of: a power takeoff speed or range of power takeoff speeds; a hydraulic coupling output pressure or range of hydraulic coupling output pressures; a three-point hitch height or range of three-point hitch heights; and a guardrail safety distance.

10. The automatic implement recognition system of claim 8, wherein the operational setting for the tractor is selected from a group of operational settings for the tractor consisting of: steering of the tractor and speed of the tractor.

11. The automatic implement recognition system of claim 8, wherein the tractor comprises an electric motor and a battery to power the electric motor and wherein the instructions are further configured to direct the processing resource to output a notification indicating an estimated remaining battery duration based on the comparison.

12. The automatic implement recognition system of claim 1, wherein instructions are configured to cause the processing resource to carry out the optical flow on the series of images captured by the camera (1) in response to and during pulling of the candidate implement by the tractor or (2) in response to and during raising or lowering of the candidate implement by the tractor.

13. The automatic implement recognition system of claim 1 further comprising a library of stored implement contours including the stored implement contour and a second stored implement contour, wherein the stored implement contour is a contour of an implement in a first implement state and wherein the second stored implement contour is a contour of the implement in a second implement state different than the first implement state.

14. The automatic implement recognition system of claim 1, wherein the instructions are configured to direct the processing resource to determine a state of the candidate implement based upon the comparison of the contour to the stored implement contour.

15. The automatic implement recognition system of claim 14, wherein the candidate implement has portions movable between a first position and a second position and wherein the state of the candidate implement comprises whether the candidate implement is at the first position or at the second position.

16. The automatic implement recognition system of claim 14, wherein the candidate implement comprises extendable and retractable wings, wherein the first position is a retracted position of the wings and wherein the second position is an extended position of the wings.

17. The automatic implement recognition system of claim 1, wherein the instructions are to direct the processing resource to:
carry out optical flow on a series of images captured by the camera during movement of a first portion of the candidate implement while a second portion of the candidate implement is stationary;
aggregate particular pixels based on relative pixel motion and classifying the particular pixels as belonging to the first portion of candidate implement;
determine a movable portion contour based on the particular pixels classified as belonging to the first portion;
compare the contour and the movable portion contour to a stored implement contour and a stored movable portion contour; and
output control signals to adjust operation of at least one of the tractor and the candidate implement based on the comparison.

18. The automatic implement recognition system of claim 1, wherein the instructions are configured to direct the processing resource to:
carry out optical flow on a series of images captured by the camera during movement of a first portion of the candidate implement while a second portion of the candidate implement is stationary;
aggregate particular pixels based on relative pixel motion and classifying the particular pixels as belonging to the first portion of candidate implement;
determine a movable portion contour based on the particular pixels classified as belonging to the first portion;
compare the movable portion contour to a stored movable portion contour;
determine a state of the first portion of the candidate implement based upon the comparison of the movable portion contour to the stored movable portion contour; and
output control signals to adjust operation of at least one of the tractor and the candidate implement based on the determined state of the first portion of the candidate implement.

19. A non-transitory computer-readable medium containing instructions configured to direct a processing resource to:
carry out optical flow on a series of images captured by the camera during movement of the candidate implement;
aggregate particular pixels based on relative pixel motion and classifying the particular pixels as belonging to the candidate implement;
determine a candidate implement contour based on the particular pixels classified as belonging to the candidate implement; and
compare the contour to a stored implement contour; and output control signals to adjust operation of at least one of the tractor and the candidate implement based on the comparison.

20. An automatic implement recognition method comprising:
carrying out optical flow on a series of images captured by the camera during movement of the candidate implement;
aggregating particular pixels based on relative pixel motion and classifying the particular pixels as belonging to the candidate implement;
determining a candidate implement contour based on the particular pixels classified as belonging to the candidate implement;
comparing the contour to a stored implement contour; and
outputting control signals to adjust operation of at least one of the tractor and the candidate implement based on the comparison.
